(19) United States
(12) Patent Application Publication
(10) Pub. No.: US 2026/0247406 A1
(43) Pub. Date: Aug. 20, 2026

(54) METHODS AND APPARATUSES OF RESOURCE SELECTION FOR SIDELINK COMMUNICATION

(71) Applicant: LENOVO (BEIJING) LIMITED, Beijing (CN)

(72) Inventors: Xin GUO, Beijing (CN); Haipeng LEI, Beijing (CN); Zhennian SUN, Beijing (CN); Xiaodong YU, Beijing (CN)

(21) Appl. No.: 18/851,406

(22) PCT Filed: Mar. 30, 2022
(86) PCT No.: PCT/CN2022/084230

§ 371 Date: Sep. 26, 2024

(51) Int. Cl. H04W 72/25; H04B 17/318; H04L 5/00

(52) U.S. Cl. CPC H04W 72/25; H04B 17/328; H04L 5/0055

(57) ABSTRACT

Embodiments of the present disclosure relate to methods and apparatuses of resource selection for sidelink (SL) communication. According to an embodiment of the present disclosure, a user equipment (UE) can include: a processor configured to: obtain configuration information indicating at least one of: time offset threshold(s) for processing resource collision; number threshold(s) of remaining resources for retransmission of a transport block (TB); ratio threshold(s) of unreserved resources; or a set of position characteristics, wherein each position characteristic indicates whether a position in an SL slot is an available position (AP) or a non-available position (NAP) for simultaneous sub-slot level transmission and slot level transmission; determine a first set of slot level candidate resources in a selection window (SW); and select a second set of slot level candidate resources from the first set of slot level candidate resources based on a sensing result in a sensing window and at least one of the following principles: principle 0: prioritizing slot level candidate resource(s) not reserved for SL transmission and slot level candidate resource(s) associated with a measured reference signal receiving power (RSRP) lower than or equal to an RSRP threshold; principle 1: prioritizing slot level candidate resource(s) reserved only for slot level transmission over that reserved only for sub-slot level transmission or reserved for both slot level transmission and sub-slot level transmission; principle 2: prioritizing slot level candidate resource(s) reserved for retransmission of a TB over that reserved for initial transmission of a TB; or principle 3: prioritizing slot level candidate resource(s) in which ratio(s) of unreserved resources is larger than or equal to a ratio threshold indicated by the configuration information; a transmitter coupled to the processor; and a receiver coupled to the processor.

### TECHNICAL FIELD

Embodiments of the present application are related to wireless communication technology, and more particularly, related to methods and apparatuses of resource selection for sidelink (SL) communication.

### BACKGROUND

A sidelink is a long-term evolution (LTE) feature introduced in 3rd generation partnership project (3GPP) Release 12, and enables a direct communication between proximal user equipments (UEs), in which data does not need to go through a base station (BS) or a core network. A sidelink communication system has been introduced into 3GPP 5G wireless communication technology, in which a direct link between two UEs is called a sidelink.

3GPP 5G networks are expected to increase network throughput, coverage and reliability and to reduce latency and power consumption. With the development of 3GPP 5G networks, various aspects need to be studied and developed to perfect the 5G technology. Currently, details regarding resource selection for sidelink communication need to be further discussed in 3GPP 5G technology.

### SUMMARY OF THE APPLICATION

Embodiments of the present application at least provide a technical solution of resource selection for sidelink communication.

According to some embodiments of the present application, a user equipment (UE) may include: a processor configured to: obtain configuration information indicating at least one of: time offset threshold(s) for processing resource collision; number threshold(s) of remaining resources for retransmission of a transport block (TB); ratio threshold(s) of unreserved resources; or a set of position characteristics, wherein each position characteristic indicates whether a position in an SL slot is an available position (AP) or a non-available position (NAP) for simultaneous sub-slot level transmission and slot level transmission; determine a first set of slot level candidate resources in a selection window (SW); and select a second set of slot level candidate resources from the first set of slot level candidate resources based on a sensing result in a sensing window and at least one of the following principles: principle 0: prioritizing slot level candidate resource(s) not reserved for SL transmission and slot level candidate resource(s) associated with a measured reference signal receiving power (RSRP) lower than or equal to an RSRP threshold; principle 1: prioritizing slot level candidate resource(s) reserved only for slot level transmission over that reserved only for sub-slot level transmission or reserved for both slot level transmission and sub-slot level transmission; principle 2: prioritizing slot level candidate resource(s) reserved for retransmission of a TB over that reserved for initial transmission of a TB; or principle 3: prioritizing slot level candidate resource(s) in which ratio(s) of unreserved resources is larger than or equal to a ratio threshold indicated by the configuration information; a transmitter coupled to the processor; and a receiver coupled to the processor.

In some embodiments of the present application, the processor is further configured to select a set of sub-slot level candidate resources from the second set of slot level candidate resources based on: principle 4: prioritizing sub-slot level candidate resource(s) on AP(s) over that on NAP(s) in a slot level candidate resource.

In some embodiments of the present application, the configuration information is configured or pre-configured per resource pool.

In some embodiments of the present application, the time offset threshold(s) includes a set of time offset thresholds, wherein each time offset threshold is associated with at least one of a priority of a TB for which the UE performs the selecting or a priority of a TB for which resource(s) in the SW is reserved; the number threshold(s) includes a set of number thresholds, wherein each number threshold is associated with at least one of a priority of a TB for which the UE performs the selecting or a priority of a TB for which resource(s) in the SW is reserved; or the ratio threshold(s) includes a set of ratio thresholds, wherein each ratio threshold is associated with at least one of a priority of a TB for which the UE performs the selecting or a priority of a TB for which resource(s) in the SW is reserved.

In some embodiments of the present application, the receiver is configured to receive sidelink control information (SCI) in the sensing window, wherein the SCI indicates that resource(s) in the SW is reserved for an SL transmission; and the processor is further configured to determine whether a type of the SL transmission is a slot level transmission or a sub-slot level transmission based on the SCI.

In some embodiments of the present application, the processor is configured to determine the type of the SL transmission according to a field of transmission type in the SCI or a unit of reserved resource(s) in the time domain indicated by the SCI.

In some embodiments of the present application, the processor is configured to prioritize slot level candidate resource(s) reserved for retransmission of a TB further based on at least one of the following principles: prioritizing a slot level candidate resource reserved for retransmission of a TB when hybrid automatic repeat request (HARQ) feedback associated with a preceding transmission of the TB is acknowledgement (ACK) or HARQ feedback for the TB is disabled; prioritizing a slot level candidate resource reserved for retransmission of a TB over that reserved for retransmission of another TB when HARQ feedbacks associated with a preceding transmission of the TB and that of the another TB are non-acknowledgement (NACK) and a number of remaining resources for retransmission of the TB is larger than that for retransmission of the another TB; prioritizing a slot level candidate resource reserved for retransmission of a TB when HARQ feedback associated with a preceding transmission of the TB is NACK and a number of remaining resources for retransmission of the TB is larger than or equal to a number threshold indicated by the configuration information; or prioritizing a slot level candidate resource reserved for retransmission of a TB when a time offset from a physical sidelink feedback channel (PSFCH) transmitting a resource collision indicator to the slot level candidate resource is larger than or equal to a time offset threshold indicated by the configuration information.

In some embodiments of the present application, the processor is configured to prioritize sub-slot level candidate resource(s) on AP(s) further based on: prioritizing a sub-slot level candidate resource on an AP over that on another AP being located prior to the AP in a same slot.

In some embodiments of the present application, to select the second set of slot level candidate resources, the processor is configured to perform: step 1: selecting slot level candidate resource(s) from the first set of slot level candidate resources as a first part of the second set of slot level candidate resources by applying principle 0; step 2: determining whether a first ratio of a number of slot level candidate resources included in the first part to a number of slot level candidate resources included in the first set of slot level candidate resources is larger than or equal to a first threshold; and step 3: in the case that the first ratio is less than the first threshold, increasing the RSRP threshold by a pre-defined step and repeating the step 1 until at least one of the following conditions is reached: (1) the first ratio is larger than or equal to the first threshold; (2) the RSRP threshold reaches a first pre-defined value; or (3) a number of times the RSRP threshold is increased reaches a second pre-defined value.

In some embodiments of the present application, the processor is further configured to indicate the set of sub-slot level candidate resources and a type associated with each sub-slot level candidate resource in the set of sub-slot level candidate resources to a higher layer of the UE, wherein the type associated with a respective sub-slot level candidate resource indicates whether the respective sub-slot level candidate resource is reserved for SL transmission or not.

In some embodiments of the present application, the processor is further configured to select a sub-slot level candidate resource from the set of sub-slot level candidate resources via a random procedure based on a type associated with the sub-slot level candidate resource and different probabilities for different types.

According to some embodiments of the present application, a BS may include: a transmitted configured to: transmit configuration information associated with resource selection, wherein the configuration information indicates at least one of: time offset threshold(s) for processing resource collision; number threshold(s) of remaining resources for retransmission of a TB; ratio threshold(s) of unreserved resources; or a set of position characteristics, wherein each position characteristic indicates whether a position in an SL slot is an AP or a NAP for simultaneous sub-slot level transmission and slot level transmission; a processor coupled to the transmitter; and a receiver coupled to the processor.

According to some other embodiments of the present application, a method performed by a UE may include: obtaining configuration information indicating at least one of: time offset threshold(s) for processing resource collision; number threshold(s) of remaining resources for retransmission of a TB; ratio threshold(s) of unreserved resources; or a set of position characteristics, wherein each position characteristic indicates whether a position in an SL slot is an AP or a NAP for simultaneous sub-slot level transmission and slot level transmission; determining a first set of slot level candidate resources in an SW; and selecting a second set of slot level candidate resources from the first set of slot level candidate resources based on a sensing result in a sensing window and at least one of the following principles: prioritizing slot level candidate resource(s) not reserved for SL transmission and slot level candidate resource(s) associated with a measured RSRP lower than or equal to an RSRP threshold; prioritizing slot level candidate resource(s) reserved only for slot level transmission over that reserved only for sub-slot level transmission or reserved for both slot level transmission and sub-slot level transmission; prioritizing slot level candidate resource(s) reserved for retransmission of a TB over that reserved for initial transmission of a TB; or prioritizing slot level candidate resource(s) in which ratio(s) of unreserved resources is larger than or equal to a ratio threshold indicated by the configuration information.

In some embodiments of the present application, the method further includes selecting a set of sub-slot level candidate resources from the second set of slot level candidate resources based on: principle 4 : prioritizing sub-slot level candidate resource(s) on AP(s) over that on NAP(s) in a slot level candidate resource.

In some embodiments of the present application, the configuration information is configured or pre-configured per resource pool.

In some embodiments of the present application, the time offset threshold(s) includes a set of time offset thresholds, wherein each time offset threshold is associated with at least one of a priority of a TB for which the UE performs the selecting or a priority of a TB for which resource(s) in the SW is reserved; the number threshold(s) includes a set of number thresholds, wherein each number threshold is associated with at least one of a priority of a TB for which the UE performs the selecting or a priority of a TB for which resource(s) in the SW is reserved; or the ratio threshold(s) includes a set of ratio thresholds, wherein each ratio threshold is associated with at least one of a priority of a TB for which the UE performs the selecting or a priority of a TB for which resource(s) in the SW is reserved.

In some embodiments of the present application, the method further includes: receiving SCI in the sensing window, wherein the SCI indicates that resource(s) in the SW is reserved for an SL transmission; and determining whether a type of the SL transmission is a slot level transmission or a sub-slot level transmission based on the SCI.

In some embodiments of the present application, the type of the SL transmission is determined according to a field of transmission type in the SCI or a unit of reserved resource(s) in the time domain indicated by the SCI.

In some embodiments of the present application, prioritizing slot level candidate resource(s) reserved for retransmission of a TB includes prioritizing slot level candidate resource(s) reserved for retransmission of a TB further based on at least one of the following principles: prioritizing a slot level candidate resource reserved for retransmission of a TB when HARQ feedback associated with a preceding transmission of the TB is ACK or HARQ feedback for the TB is disabled; prioritizing a slot level candidate resource reserved for retransmission of a TB over that reserved for retransmission of another TB when HARQ feedbacks associated with a preceding transmission of the TB and that of the another TB are NACK and a number of remaining resources for retransmission of the TB is larger than that for retransmission of the another TB; prioritizing a slot level candidate resource reserved for retransmission of a TB when HARQ feedback associated with a preceding transmission of the TB is NACK and a number of remaining resources for retransmission of the TB is larger than or equal to a number threshold indicated by the configuration information; or prioritizing a slot level candidate resource reserved for retransmission of a TB when a time offset from a PSFCH transmitting a resource collision indicator to the slot level candidate resource is larger than or equal to a time offset threshold indicated by the configuration information.

In some embodiments of the present application, prioritizing sub-slot level candidate resource(s) on AP(s) includes prioritizing sub-slot level candidate resource(s) on AP(s) further based on: prioritizing a sub-slot level candidate resource on an AP over that on another AP being located prior to the AP in a same slot.

In some embodiments of the present application, selecting the second set of slot level candidate resources includes: step 1: selecting slot level candidate resource(s) from the first set of slot level candidate resources as a first part of the second set of slot level candidate resources by applying principle 0; step 2: determining whether a first ratio of a number of slot level candidate resources included in the first part to a number of slot level candidate resources included in the first set of slot level candidate resources is larger than or equal to a first threshold; and step 3: in the case that the first ratio is less than the first threshold, increasing the RSRP threshold by a pre-defined step and repeating the step 1 until at least one of the following conditions is reached: (1) the first ratio is larger than or equal to the first threshold; (2) the RSRP threshold reaches a first pre-defined value; or (3) a number of times the RSRP threshold is increased reaches a second pre-defined value.

In some embodiments of the present application, the method further includes indicating the set of sub-slot level candidate resources and a type associated with each sub-slot level candidate resource in the set of sub-slot level candidate resources to a higher layer of the UE, wherein the type associated with a respective sub-slot level candidate resource indicates whether the respective sub-slot level candidate resource is reserved for SL transmission or not.

In some embodiments of the present application, the method further includes selecting a sub-slot level candidate resource from the set of sub-slot level candidate resources via a random procedure based on a type associated with the sub-slot level candidate resource and different probabilities for different types.

According to some other embodiments of the present application, a method performed by a BS may include: transmitting configuration information associated with resource selection, wherein the configuration information indicates at least one of: time offset threshold(s) for processing resource collision; number threshold(s) of remaining resources for retransmission of a TB; ratio threshold(s) of unreserved resources; or a set of position characteristics, wherein each position characteristic indicates whether a position in an SL slot is an AP or a NAP for simultaneous sub-slot level transmission and slot level transmission.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 is a schematic diagram illustrating an exemplary wireless communication system according to some embodiments of the present application;

FIG. 2 illustrates two exemplary sidelink slot patterns according to some embodiments of the present application;

FIG. 3 illustrates an exemplary sidelink sub-slot pattern according to some embodiments of the present application;

FIG. 4 illustrates another exemplary sidelink sub-slot pattern according to some other embodiments of the present application;

FIG. 5 illustrates an exemplary sensing-based resource (re-)selection procedure according to some embodiments of the present application.

FIG. 6 illustrates an example of resource selection according to some embodiments of the present application.

FIG. 7 illustrates a flowchart of an exemplary method for resource selection according to some embodiments of the present application;

FIG. 8 illustrates an example of three types of candidate resources according to some embodiments of the present application;

FIG. 9 illustrates an example of principle 2 of resource selection according to some embodiments of the present application;

FIG. 10 illustrates an example of principle 2.1 of resource selection according to some embodiments of the present application;

FIG. 11 illustrates an example of principle 2.2 or principle 2.3 of resource selection according to some embodiments of the present application;

FIG. 12 illustrates an example of principle 2.4 of resource selection according to some embodiments of the present application;

FIG. 13 illustrates an example of principle 3 of resource selection according to some embodiments of the present application; and

FIG. 14 illustrates a simplified block diagram of an exemplary apparatus for resource selection according to some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP LTE and LTE advanced, 3GPP 5G new radio (NR), 5G-Advanced, 6G, and so on. It is contemplated that along with developments of network architectures and new service scenarios, all embodiments in the present application are also applicable to similar technical problems; and moreover, the terminologies recited in the present application may change, which should not affect the principle of the present application.

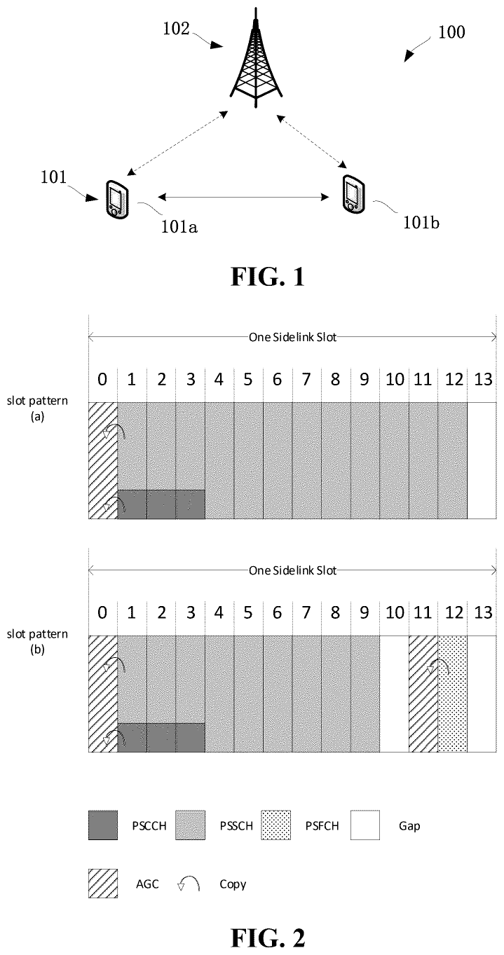

FIG. 1 illustrates an exemplary wireless communication system 100 in accordance with some embodiments of the present application.

As shown in FIG. 1, the wireless communication system 100 includes at least one UE 101 and at least one BS 102. In particular, the wireless communication system 100 includes two UEs 101 (e.g., UE 101a and UE 101b) and one BS 102 for illustrative purpose. Although a specific number of UEs 101 and BS 102 are depicted in FIG. 1, it is contemplated that any number of UEs 101 and BSs 102 may be included in the wireless communication system 100.

According to some embodiments of the present application, the UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like.

According to some other embodiments of the present application, the UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network.

According to some other embodiments of the present application, the UE(s) 101 may include wearable devices, such as smart watches, fitness bands, optical head-mounted displays, or the like.

According to some embodiments of the present application, the UE(s) 101 may include vehicle UEs (VUEs) and/or power-saving UEs (also referred to as power sensitive UEs). The power-saving UEs may include vulnerable road users (VRUs), public safety UEs (PS-UEs), and/or commercial sidelink UEs (CS-UEs) that are sensitive to power consumption. In an embodiment of the present application, a VRU may include a pedestrian UE (P-UE), a cyclist UE, a wheelchair UE or other UEs which require power saving compared with a VUE.

Moreover, the UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

In a sidelink communication system, a transmission UE may also be named as a transmitting UE, a Tx UE, a sidelink Tx UE, a sidelink transmission UE, or the like. A reception UE may also be named as a receiving UE, an Rx UE, a sidelink Rx UE, a sidelink reception UE, or the like.

According to some embodiments of FIG. 1, UE 101a functions as a Tx UE, and UE 101b functions as an Rx UE. UE 101a may exchange sidelink messages with UE 101b through a sidelink, for example, via PC5 interface as defined in 3GPP TS 23.303. UE 101a may transmit information or data to other UE(s) within the sidelink communication system, through sidelink unicast, sidelink groupcast, or sidelink broadcast. For instance, UE 101a may transmit data to UE 101b in a sidelink unicast session. UE 101a may transmit data to UE 101b and other UE(s) in a groupcast group (not shown in FIG. 1) by a sidelink groupcast transmission session. Also, UE 101a may transmit data to UE 101b and other UE(s) (not shown in FIG. 1) by a sidelink broadcast transmission session.

Alternatively, according to some other embodiments of FIG. 1, UE 101b functions as a Tx UE and transmits sidelink messages, and UE 101a functions as an Rx UE and receives the sidelink messages from UE 101b.

Both UE 101a and UE 101b in the embodiments of FIG. 1 may transmit information to BS(s) 102 and receive control information from BS(s) 102, for example, via LTE or NR Uu interface. BS(s) 102 may be distributed over a geographic region. In certain embodiments of the present application, each of BS(s) 102 may also be referred to as an access point, an access terminal, a base, a base unit, a macro cell, a Node-B, an evolved Node B (eNB), a gNB, a Home Node-B, a relay node, or a device, or described using other terminology used in the art. BS(s) 102 is generally a part of a radio access network that may include one or more controllers communicably coupled to one or more corresponding BS(s) 102.

The wireless communication system 100 may be compatible with any type of network that is capable of sending and receiving wireless communication signals. For example, the wireless communication system 100 is compatible with a wireless communication network, a cellular telephone network, a Time Division Multiple Access (TDMA)-based network, a Code Division Multiple Access (CDMA)-based network, an Orthogonal Frequency Division Multiple Access (OFDMA)-based network, an LTE network, a 3GPP-based network, a 3GPP 5G network, a satellite communications network, a high altitude platform network, and/or other communications networks.

In some embodiments of the present application, the wireless communication system 100 is compatible with the 5G NR of the 3GPP protocol, wherein BS(s) 102 transmit data using an orthogonal frequency division multiplexing (OFDM) modulation scheme on the downlink (DL) and UE(s) 101 transmit data on the uplink (UL) using a Discrete Fourier Transform-Spread-Orthogonal Frequency Division Multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present application, BS(s) 102 may communicate using other communication protocols, such as the IEEE 802.11 family of wireless communication protocols. Further, in some embodiments of the present application, BS(s) 102 may communicate over licensed spectrums, whereas in other embodiments, BS(s) 102 may communicate over unlicensed spectrums. The present application is not intended to be limited to the implementation of any particular wireless communication system architecture or protocol. In yet some embodiments of the present application, BS(s) 102 may communicate with UE(s) 101 using the 3GPP 5G protocols. slot in which a sidelink communication may be performed can be referred to as a sidelink slot. Although a resource pool configuration has a slot-based granularity in the time domain, this does not preclude the case in which only a limited set of consecutive symbols within a sidelink slot is actually available for sidelink communication. The limited set of consecutive symbols can be configured by the first symbol of the set of consecutive symbols available for sidelink communication and the number of consecutive symbols available for sidelink communication. Without loss of generality, this application only illustrates examples where all 14 OFDM symbols within a sidelink slot are available for sidelink communication. As per NR sidelink slot specified in 3GPP Rel-16, the first symbol of the available OFDM symbols for sidelink communication of a sidelink slot is a copy of the second symbol of the available OFDM symbols for sidelink communication of the sidelink slot; and the first symbol of the available OFDM symbols for sidelink communication is used for an automatic gain control (AGC) purpose. The operation of AGC is performed by a UE when receiving a signal to determine an amplification degree, and thus, the UE can adjust the gain of a receiver amplifier to fit the power of the received signal. The specific examples of a sidelink slot are shown in FIG. 2, which are described as below.

FIG. 2 illustrates two exemplary sidelink slot patterns (or formats) according to some embodiments of the present application. As shown in FIG. 2, the two exemplary sidelink slot patterns may be referred to as slot pattern (a) and slot pattern (b). In the slot pattern (a) and slot pattern (b), one sidelink slot includes 14 OFDM symbols in total, e.g., OFDM symbol #0 to OFDM symbol #13. OFDM symbol #0 is used for AGC by repeating the first OFDM symbol (e.g., OFDM symbol #1) carrying physical sidelink shared channel (PSSCH) and/or physical sidelink control channel (PSCCH) transmissions. The last available OFDM symbol, e.g., OFDM symbol #13, is always used as a guard symbol (e.g., a gap). In addition, OFDM symbol #1, OFDM symbol #2, and OFDM symbol #3 are used to carry PSSCH and PSCCH transmissions. OFDM Symbol #4 to OFDM symbol #9 are used to carry PSSCH transmissions. An OFDM symbol carrying PSSCH and/or PSCCH transmissions may be named as “a PSSCH and/or PSCCH OFDM symbol,” “a PSSCH and/or PSCCH symbol,” or the like.

In the embodiments of FIG. 2, the difference between slot pattern (a) and slot pattern (b) lies in OFDM Symbol #10 to OFDM symbol #12. Specifically, in slot pattern (a), OFDM Symbol #10 to OFDM symbol #12 are used to carry PSSCH transmissions. However, in slot pattern (b), the hybrid automatic repeat request (HARQ) feedback is enabled for the sidelink slot, and then a physical sidelink feedback channel (PSFCH) transmission is transmitted in the second last available OFDM symbol (e.g., OFDM symbol #12 as shown in slot pattern (b) in FIG. 2) of the sidelink slot. An OFDM symbol carrying a PSFCH transmission may be named as “a PSFCH OFDM symbol,” “a PSFCH symbol,” or the like. One OFDM symbol right prior to the PSFCH symbol may be used for AGC and may include a copy of the PSFCH symbol. For example, OFDM symbol #11 as shown in slot pattern (b) in FIG. 2 is used for AGC by repeating the PSFCH symbol (e.g., OFDM symbol #12 as shown in slot pattern (b) in FIG. 2).

In some embodiments, a guard symbol (e.g., OFDM symbol #10 as shown in slot pattern (b) in FIG. 2) between the PSSCH and/or PSCCH symbol and the PSFCH symbol is needed to provide switching time between “a PSSCH and/or PSCCH transmission/reception” and “a PSFCH transmission.” This implies that, if PSFCH resources are configured for a sidelink slot, this will use a total of three OFDM symbols, including the AGC symbol and the extra guard symbol.

The sidelink slot patterns shown in FIG. 2 are provided for purpose of illustration. It is contemplated that other sidelink slot patterns may be applied.

Considering that the AGC setting time occupies only 15 microseconds (i.e., μsec or us), and the assumption for the necessary transmission/reception (Tx/Rx) switching gap is 13 μsec while the symbol duration for 15 kHz subcarrier spacing (SCS) is equal to 66.67 μsec and the symbol duration for 30 kHz SCS is equal to 33.33 μsec, it is inefficient to use a whole symbol working as AGC for some SCS, such as 15 kHz or 30 kHz.

Currently, in emerging latency critical applications (e.g., a factory automation scenario, automatic driving scenario, and so on), lower latency requirements are needed and thus cannot be satisfied by a slot-based sidelink transmission. For example, if SCSs are configured per resource pool and if a desired resource pool is configured with a shorter SCS (such as, 15 kHz or 30 kHz), it is required to reduce the transmission latency for the configured SCS. This implies that the latency on the resource pool cannot be reduced by applying a longer SCS. Therefore, sub-slot based sidelink slot pattern (or format) is introduced in supporting low latency and high spectrum efficiency sidelink transmission. A sidelink sub-slot (SS) may refer to a fraction of a sidelink slot or a limited set of consecutive symbols within a sidelink slot. A sidelink SS may also be named as “a sub-slot,” “a sidelink mini-slot,” “a mini-slot,” or the like. In some embodiments, the sidelink sub-slot may include the following components such as full-symbol (FS), half-symbol (HS), and combined-symbol (CS).

For instance, the following three types of FS are defined.
(1) FS₁ is defined as an FS which is for carrying PSSCH and/or PSCCH transmissions.
(2) FS₂ is defined as an FS which is for carrying a PSSCH transmission.
(3) FS₃ is defined as an FS which is for carrying a PSFCH transmission.

For instance, the following four types of HS are defined.
(1) HS₁ is defined as an HS which is “a copy of the first half of the nearest PSSCH and/or PSCCH symbol after the HS” or “a copy of the first half of the nearest PSFCH symbol after the HS.” For example, HS₁ can be used for AGC.
(2) HS₂ is defined as an HS which works as a gap for Tx/Rx switching.
(3) HS₃ is defined as an HS which is “a copy of the second half of the nearest PSSCH and/or PSCCH symbol before the HS” or “a copy of the second half of the nearest PSFCH symbol before the HS.” For example, HS₃ can be used for reliability improvement.
(4) HS₄ is defined as an HS carrying extra information by transmitting a preamble sequence. The information carried in HS₄ can be used for supporting a sub-slot based transmission. For example, HS₄ can be used for increasing spectrum efficiency. Or, HS₄ can be used for padding a symbol.

For instance, the following four types of CS are defined.
(1) CS1 is defined as including two half-symbols, in which the first half of the combined-symbol is HS₁, and the second half of the combined-symbol is HS₄.
(2) CS2 is defined as including two half-symbols, in which the first half of the combined-symbol is HS₃, and the second half of the combined-symbol is HS₂.
(3) CS3 is defined as including two half-symbols, in which the first half of the combined-symbol is HS₂, and the second half of the combined-symbol is HS₁.
(4) CS4 is defined as including two half-symbols, in which the first half of the combined-symbol is HS₄, and the second half of the combined-symbol is HS₂.

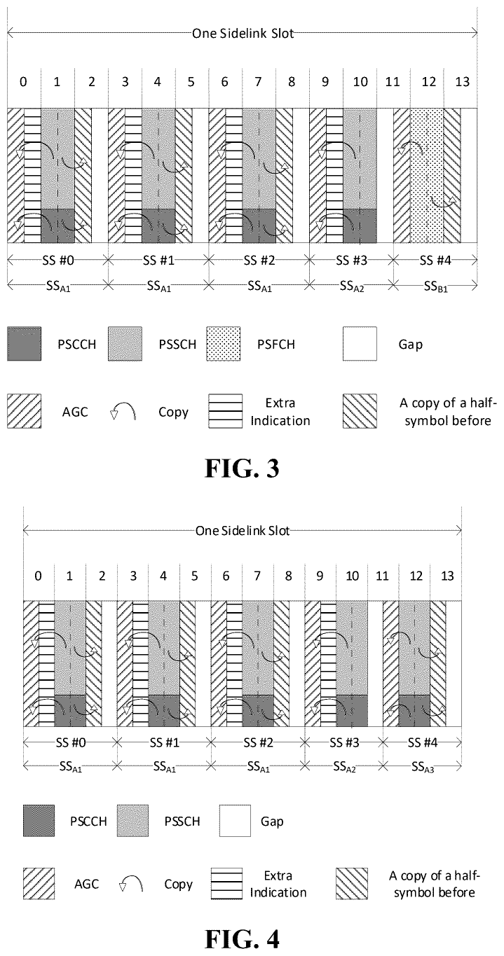

Currently, for instance, the following two types of sidelink sub-slots are defined.
(1) Sub-slot type SSA does not include symbol(s) of a PSFCH transmission. That is, SSA includes only “PSSCH and/or PSCCH transmissions” or only “a PSSCH transmission.” Sub-slot type SSA can be further classified as follows:
   a) Sub-slot type SS_{A1} includes one CS₁, at least one FS₁, and one CS₂.
   b) Sub-slot type SS_{A2} includes one CS₁, at least one FS₁, and one HS₂.
   c) Sub-slot type SS_{A3} includes one HS₁, at least one FS₁, and one CS₂.
   d) Sub-slot type SS_{A4} includes one HS₁, at least one FS₁, and one HS₂.
(2) Sub-slot type SS_{B} does not include symbol(s) of PSSCH and/or PSCCH transmissions. That is, SS_{B} includes only a PSFCH transmission. Sub-slot type SS_{B} can be further classified as follows:
   a) Sub-slot type SS_{B1} includes one HS₁, at least one FS₃, and one CS₂.
   b) Sub-slot type SS_{B2} includes one HS₁, at least one FS₃, and one CS₄.
   c) Sub-slot type SS_{B3} includes one HS₁, at least one FS₃, and one HS₂.
FIG. 3 illustrates an exemplary sidelink sub-slot pattern according to some embodiments of the present application. In the embodiments of FIG. 3, one sidelink slot includes 14 OFDM symbols in total, e.g., OFDM symbol #0 to OFDM symbol #13.

According to the embodiments of FIG. 3, the sidelink slot as illustrated by FIG. includes five sidelink sub-slots in total, e.g., SS #0, SS #1, SS #2, SS #3, and SS #4. All of SS #0, SS #1, and SS #2 belong to sub-slot type SSA1, which includes one CS₁, one FS₁ and one CS₂. SS #3 belongs to sub-slot type SS_{A2}, which includes one CS₁, one FS₁ and one HS₂. SS #4 belongs to sub-slot type SS_{B1}, which includes one HS₁, one FS₃ and one CS₂.

FIG. 4 illustrates another exemplary sidelink sub-slot pattern according to some other embodiments of the present application. In the embodiments of FIG. 4, one sidelink slot includes 14 OFDM symbols in total, e.g., OFDM symbol #0 to OFDM symbol #13.

According to the embodiments of FIG. 4, the sidelink slot as illustrated by FIG. 4 includes five sidelink sub-slots in total, e.g., SS #0, SS #1, SS #2, SS #3, and SS #4. All of SS #0, SS #1, SS #2, and SS #3 are the same as SS #0, SS #1, SS #2, and SS #3 in FIG. 3, respectively. The difference between FIG. 3 and FIG. 4 is that in the embodiments of FIG. 4, SS #4 belongs to sub-slot type SS_{A3}, which includes one HS₁, one FS₁, and one CS₂.

The sidelink sub-slot patterns (also referred to as sub-slot patterns) in FIGS. 3 and 4 are only for illustrative purpose. It is contemplated that the sub-slot patterns may be other patterns according to some other embodiments of the present application, and that one slot may include other numbers of sub-slots.

For sidelink transmission, resource allocation may be implemented by two modes, i.e., resource allocation mode 1 and resource allocation mode 2.

In the case of resource allocation mode 1, a sidelink transmission (e.g., a PSSCH transmission and/or a PSCCH transmission) can only be carried out by a UE if the UE has been provided with a valid scheduling grant that indicates the exact set of resources used for the sidelink transmission. Assuming that both slot level resource allocation (i.e., resource allocation for slot-based or slot level sidelink transmission) and sub-slot level resource allocation (i.e., resource allocation for sub-slot based or sub-slot level sidelink transmission) are configured in one resource pool (RP), dynamic grant implies that the scheduling grant can be made in different time intervals, i.e., either slot or sub-slot.

In the case of resource allocation mode 2, a decision on sidelink transmission, including decision on the exact set of resources to be used for the sidelink transmission, is made by the transmitting UE (also referred to as Tx UE) based on a sensing-based resource (re-)selection procedure. Resource allocation mode 2 is applicable to both in-coverage and out-of-coverage deployment scenarios.

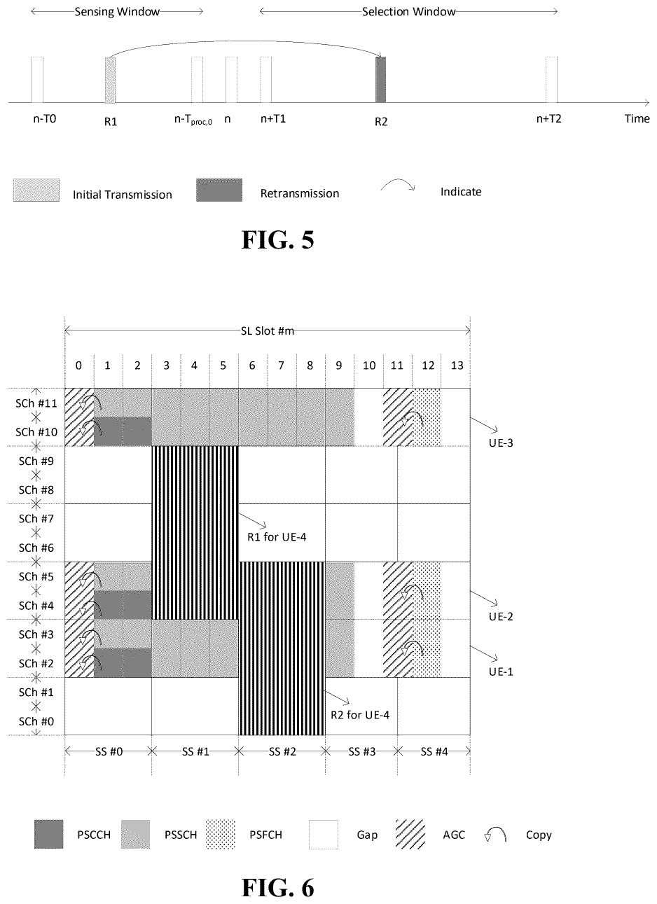

FIG. 5 illustrates an exemplary sensing-based resource (re-)selection procedure according to some embodiments of the present application. The procedure in FIG. 5 may be used for selecting a slot level resource for a slot level sidelink transmission.

Referring to FIG. 5, the resource (re-)selection is triggered at a slot n by a UE or new resource(s) for transmitting a TB must be selected at slot n by a UE. The UE may define a selection window (SW) in which the UE determines candidate resources for transmitting the TB. The SW may start at slot n+T1 and end at slot n+T2, wherein T1 and T2 are constrained by conditions as specified in 3GPP standard documents.

Once the SW is defined, the UE may identify a set of candidate resources (referred to as set “S”) within the SW. The set “S” may include all the candidate resources within the SW. For example, a candidate resource (e.g., a slot level candidate resource) may be defined by a slot in the time domain and LpssCH contiguous sub-channels in the frequency domain. LPsSCH is a positive integer and may depend on a size of the TB and associated SCI as well as the modulation and coding scheme (MCS) utilized by the UE for transmitting the TB.

In order to select candidate resources from the set “S”, the UE may perform a sensing operation in a sensing window which starts at slot n-T0 and ends at slot n-T_{proc,0}, wherein T0 and T_{proc,0} are constrained by conditions as specified in 3GPP standard documents.

During the sensing operation, the UE may sense SL resources within the sensing window, and decode SCIs (e.g., 1^{st}-stage SCIs) received from other UEs on the sensed SL resources. For example, an initial transmission of a TB detected in the sensing window may include associated SCI. The 1^{st}-stage SCIs may indicate SL resources that other UEs have reserved for their TB and SCI transmissions in PSSCH and PSCCH. In addition, the UE may also measure RSRPs of transmissions associated with the 1^{st}-stage SCIs from other UEs. For example, as shown in FIG. 5, the UE may detect an initial transmission on resource R1 within the sensing window indicating a reserved resource in slot R2 within the SW.

After performing the sensing operation, the UE may use the sensing results (e.g., the decoded 1^{st}-stage SCIs and the measured RSRPs) to select candidate resources from the set “S” for transmitting the TB of the UE. For example, the selection may include the following steps:
1) Step 1: the UE may determine which candidate resources from the SW should be excluded, based on the sensing results (e.g., the decoded 1^{st}-stage SCIs and the measured RSRPs), to obtain a set of available candidate resources (referred to as set “S1”). That is, the set “S1” is constructed by excluding the determined candidate resources from the set “S.”
   a) First, the UE may exclude candidate resources whose reservation cannot be determined by the UE based on the sensing results in the sensing window due to half-duplexing of the UE. For example, if the UE transmits information in slot si in the sensing window, then it cannot sense SCI in slot sᵢ due to half-duplexing, so it may exclude all candidate resources which are possibly reserved by SCI in slot sᵢ. The candidate resources which are possibly reserved by SCI in slot sᵢ may be included in slot sᵢ+q*RRIᵢ (q=1, 2, 3. . . ) within the selection window, wherein RRIᵢ represents all the possible values of a resource reservation interval (RRI) based on a list of permitted RRIs in the resource pool as specified in 3GPP standard documents.
   b) Second, the UE may exclude candidate resources based on the reservations from other UEs indicated by the 1^{st}-stage SCIs detected during the sensing window. Specifically, a candidate resource may be excluded only if a measured RSRP (e.g., an RSRP of an SL transmission associated with the 1^{st}-stage SCI detected in the sensing window and indicating that the candidate resource is reserved for an SL transmission of another UE) associated with the candidate resource is higher than an RSRP threshold, wherein the RSRP threshold utilized by the UE may depend on at least one of (1) the priority of the TB for which the UE selects the candidate resources (also the priority of the SL transmission to be performed by the UE) or (2) the priority of a TB for which the another UE reserves the resource (also the priority of the SL transmission of the another UE).
2) Step 2: the UE may perform a checking process. That is, after executing all exclusions in step 1, the UE may check whether the candidate resources in the set “S1” is equal to or higher than a threshold ratio (e.g., X %) of candidate resources in the set “S.” If not, the RSRP threshold may be increased by a pre-defined step (e.g., 3 dB), and step 1 is repeated by utilizing the increased RSRP threshold until X % is fulfilled. If yes, the set “S1” will be transmitted to a higher layer (e.g., a layer higher than physical layer) of the UE. For example, possible values of X include 20, 35 or 50. In some embodiments, the UE may select the value of X based on a priority of the TB for which the UE selects the candidate resources.

Then, the UE may randomly select candidate resource(s) from the set “S1” for transmitting the TB.

As stated above, the procedure illustrated in FIG. 5 may be used for selecting a resource for a slot level sidelink transmission.

However, in the case of coexistence of slot level SL transmission (also referred to as slot level transmission) and sub-slot level SL transmission (also referred to as sub-slot level transmission) within the same RP, resources spanning one SL slot may be fully or partially reserved by one or more sub-slot level SL transmissions. In such cases, a UE which performs a slot level SL transmission may be referred to as slot-level UE or slot UE. In the same way, a UE which performs a sub-slot level SL transmission may be referred to as sub-slot level UE or sub-slot UE.

FIG. 6 illustrates an example of resource selection according to some embodiments of the present application. In the embodiments of FIG. 6, one slot (e.g., SL slot #m) may include 14 OFDM symbols in total, e.g., OFDM symbol #0 to OFDM symbol #13. Although a specific number of OFDM symbols in one sidelink slot are depicted in FIG. 6, it is contemplated that any number of OFDM symbols as specified in 3GPP standards may be included in one sidelink slot.

In the embodiments of FIGS. 6, 12 sub-channels (e.g., SCh #0 to SCh #11) are shown, and the slot includes five sub-slots (e.g., SS #0 to SS #4). UE-1, UE-2, and UE-3 are three slot UEs which may select resources for SL transmissions based on the sensing-based resource (re-)selection procedure as shown in FIG. 5. For example, UE-1 may select one slot (e.g., slot #m) in the time domain and two consecutive sub-channels from SCh #2 to SCh #3 in the frequency domain for its slot level SL transmission; UE-2 may select one slot (e.g., slot #m) in the time domain and two consecutive sub-channels from SCh #4 to SCh #5 in the frequency domain for its slot level SL transmission; UE-3 may select one slot (e.g., slot #m) in the time domain and two consecutive sub-channels from SCh #10 to SCh #11 in the frequency domain for its slot level SL transmission.

UE-4 may be a sub-slot UE which needs to select a sub-slot level resource for its sub-slot level SL transmission. A sub-slot level candidate resource may be defined by a sub-slot in the time domain and a group of contiguous sub-channels in the frequency domain, and the number of sub-channels in the group may depend on a size of the TB for which the sub-slot level SL transmission is performed and associated SCI as well as the MCS utilized by the UE for transmitting the TB. In the example shown in FIG. 6, the sub-slot level SL transmission may require one sub-slot in the time domain and six sub-channels in the frequency domain. R1 and R2 are two exemplary sub-slot level candidate resources that may be selected by UE-4. It is obvious that the impact from R1 and R2 on the transmissions from UE-1, UE-2 and UE-3 are quite different.

Therefore, how to capture various impacts to make a proper decision on identifying sub-slot level candidate resources so as to increase the transmission success probability of a sub-slot UE and decrease impact to other UEs needs to be addressed.

Embodiments of the present application provide improved solutions for resource selection in SL communication, which define principle(s) of resource selection for sub-slot UE, so as to increase the transmission success probability of the sub-slot UE and decrease impact to other UEs, thereby achieving the coexistence of sub-slot level sidelink transmission and slot level sidelink transmission, especially under resource allocation mode 2. More details on embodiments of the present application will be illustrated in the following text in combination with the appended drawings.

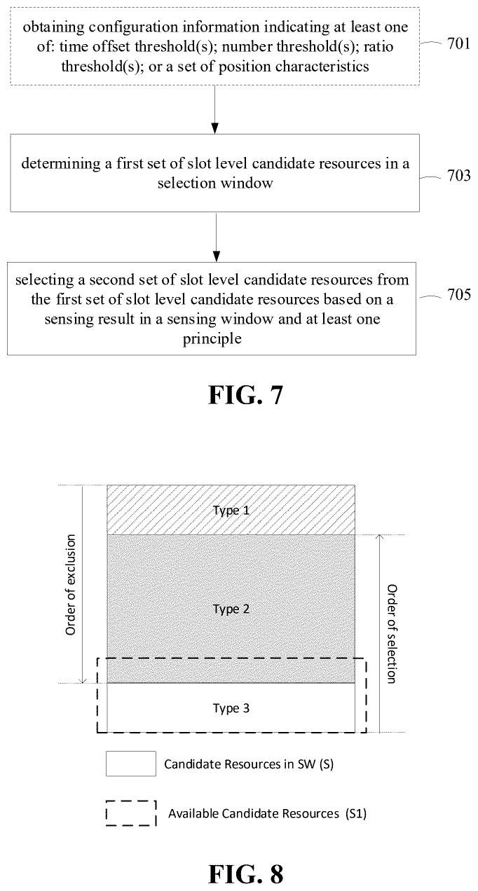

FIG. 7 illustrates a flowchart of an exemplary method for resource selection according to some embodiments of the present application. The method illustrated in FIG. 7 may be performed by a UE (e.g., UE 101a or UE 101b in FIG. 1) or other apparatus with the like functions. In the embodiments of FIG. 7, the UE may perform a sub-slot level SL transmission, and thus may also be referred to as a sub-slot level UE.

As shown in FIG. 7, in step 701, the UE may obtain configuration information which may include at least one of the following parameters: (1) time offset threshold(s) for processing resource collision; (2) number threshold(s) of remaining resources for retransmission of a TB; (3) ratio threshold(s) of unreserved resources; or (4) a set of position characteristics, wherein each position characteristic indicates whether a position in an SL slot is an AP or a NAP for simultaneous sub-slot level transmission and slot level transmission. The aforementioned parameters may be used in resource selection, which will be described in details later (e.g., with respect to step 705). Step 701 is an optional step and may not occur in some embodiments of the present application, for example, if the aforementioned parameters are not used in resource selection, step 701 may not occur.

In some embodiments of the present application, the time offset threshold(s) for processing resource collision may include a set of time offset thresholds, wherein each time offset threshold is associated with at least one of a priority of a TB for which the UE performs resource selection or a priority of a TB for which resource(s) in the SW of the UE is reserved. In some embodiments of the present application, the time offset threshold(s) for processing resource collision may include only one time offset threshold specific to the UE.

In some embodiments of the present application, the number threshold(s) of remaining resources for retransmission of a TB may include a set of number thresholds, wherein each number threshold is associated with at least one of a priority of a TB for which the UE performs resource selection or a priority of a TB for which resource(s) in the SW of the UE is reserved. In some embodiments of the present application, the number threshold(s) of remaining resources for retransmission of a TB may include only one number threshold specific to the UE.

In some embodiments of the present application, the ratio threshold(s) of unreserved resources may include a set of ratio thresholds, wherein each ratio threshold is associated with at least one of a priority of a TB for which the UE performs resource selection or a priority of a TB for which resource(s) in the SW of the UE is reserved. In some embodiments of the present application, the ratio threshold(s) of unreserved resources may include only one ratio threshold specific to the UE.

According to some embodiments of the present application, the configuration information may be configured or pre-configured per resource pool.

In some embodiments of the present application, the configuration information is configured (i.e., the configuration information is obtained based on configuration), which may refer to that: the configuration information is transmitted by a BS (e.g., BS 102 as shown in FIG. 1) to the UE via a signaling, e.g., a system information block (SIB), a master information block (MIB), a radio resource control (RRC) signaling, a medium access control (MAC) layer control element (CE), or downlink control information (DCI), such that the UE may receive the configuration information from the BS. In an embodiment of the present application, obtaining the configuration information based on configuration may apply to the scenario where the UE is in coverage of a network.

In some other embodiments of the present application, the configuration information is pre-configured (i.e., the configuration information is obtained based on pre-configuration), which may refer to that: the configuration information may be hard-wired into the UE or stored on a subscriber identity module (SIM) or universal subscriber identity module (USIM) card for the UE, such that the UE may obtain the configuration information within the UE. In an embodiment of the present application, obtaining the configuration information based on pre-configuration may apply to the scenario where the UE is out of coverage of the network.

In some embodiments of the present application, the configuration information being configured or pre-configured per resource pool may refer to that: the resource pool configuration for each RP may include the configuration information, and the resource pool configuration may be obtained based on configuration or pre-configuration as stated above.

In step 703, the UE may determine a first set of slot level candidate resources (also referred to as set “S”) in an SW (e.g., the SW in FIG. 5). The set “S” may include all the slot level candidate resources in the SW.

A slot level candidate resource may be defined by one slot in the time domain and LPSSCH-ss contiguous sub-channels in the frequency domain. L_{PSSCH-SS} may be a positive integer and depend on a size of the sub-slot level SL transmission to be performed by the UE as well as the MCS utilized by the UE. The sub-slot level SL transmission may include SCI (e.g., including 1^{st}-stage SCI and 2^{nd}-stage SCI) and a TB associated with the SCI.

In step 705, the UE may select a second set of slot level candidate resources (referred to as set “S1”) from the set “S” based on a sensing result in a sensing window (e.g., the sensing window in FIG. 5) and at least one principle.

Based on the sensing result (e.g., the SCIs detected in the sensing window and the RSRPs measured in the sensing window) obtained in the sensing window, the slot level candidate resources in the set “S” may be classified into three types (e.g., Type 1, Type 2, and Type 3). FIG. 8 illustrates an example of the three types of candidate resources in the SW (i.e., the set “S”) according to some embodiments of the present application.

Type 1 slot level candidate resources may refer to slot level candidate resources whose reservation cannot be determined by the UE based on the sensing result in the sensing window due to half-duplexing of the UE. For example, if the UE transmits information on slot sᵢ in the sensing window, then Type 1 slot level candidate resources may include all slot level candidate resources in the SW which are possibly reserved by SCI in slot sᵢ. The slot level candidate resources in the SW which are possibly reserved by SCI in slot sᵢ may be included in slot sᵢ+q*RRIᵢ (q=1, 2, 3...) within the SW, wherein RRIᵢ represents all the possible values of an RRI based on a list of permitted RRIs in the resource pool as specified in 3GPP standard documents.

A Type 2 slot level candidate resource may refer to a slot level candidate resource that is reserved for SL transmission(s) (e.g., at least one of sub-slot level transmission(s) or slot level transmission(s)). In the embodiments of the subject application, a slot level candidate resource being reserved for an SL transmission may refer to that the slot level candidate resource is fully or partially reserved for the SL transmission.

Specifically, a slot level candidate resource is determined to be reserved for an SL transmission when an SCI (e.g., 1^{st}-stage SCI) detected in the sensing window indicates that the slot level candidate resource is reserved by an SL transmission of another UE.

A Type 3 slot level candidate resource may refer to a slot level candidate resource that is not reserved for any SL transmission. Specifically, a slot level candidate resource is determined not to be reserved for any SL transmission when all the SCIs detected in the sensing window do not indicate to reserve the slot level candidate resource (excluding Type 1 slot level candidate resources).

In some embodiments of the present application, Type 2 slot level candidate resources may be further classified into:
Type 2.1 slot level candidate resources, which refer to slot level candidate resources reserved only for slot level transmission.
Type 2.2 slot level candidate resources, which refer to slot level candidate resources reserved only for sub-slot level transmission.
Type 2.3 slot level candidate resources, which refer to slot level candidate resources each reserved for both slot level transmission and sub-slot level transmission.

According to some embodiments of the present application, in step 705, the UE may select the set “S1” based on the sensing result in the sensing window and at least one of the following principles:
1) principle 0: prioritizing slot level candidate resource(s) not reserved for SL transmission (e.g., Type 3) and slot level candidate resource(s) associated with a measured RSRP lower than or equal to an RSRP threshold;
2) principle 1: prioritizing slot level candidate resource(s) reserved only for slot level transmission (e.g., Type 2.1) over that reserved only for sub-slot level transmission (e.g., Type 2.2) or reserved for both slot level transmission and sub-slot level transmission (e.g., Type 2.3);
3) principle 2: prioritizing slot level candidate resource(s) reserved for retransmission of a TB over that reserved for initial transmission of a TB; or
4) principle 3: prioritizing slot level candidate resource(s) in which ratio(s) of unreserved resources is larger than or equal to a ratio threshold indicated by the configuration information.

In some embodiments, the at least one principle may be implemented in terms of exclusion. In some other embodiments, the at least one principle may be implemented in terms of selection. For example, as shown in FIG. 8, to implement principle 0 in terms of exclusion, the UE may exclude slot level candidate resources from the set “S” in an order from Type 1 to Type 2; to implement principle 0 in terms of selection, the UE may select slot level candidate resources from the set “S” in an order from Type 3 to Type 2.

As shown in FIG. 8, the set “S1” (also referred to as available candidate resources which are circled by the dashed box) may include all the Type 3 slot level candidate resources and a part of Type 2 slot level candidate resources. Principles 0-3 may be used to select the part of Type 2 slot level candidate resources.

One motivation for principle 1 is that the priority of a slot level transmission is generally lower than that of a sub-slot level transmission since the sub-slot level transmission is introduced for urgent applications. On the other hand, Type 2.1 slot level candidate resource(s) can provide multiple contiguous sub-slots with a higher probability than Type 2.2 and Type 2.3 slot level candidate resource(s).

In order to perform resource selection based on principle 1, the UE may need to know a type of an SL transmission (e.g., whether the SL transmission is slot-level or sub-slot level) for which a candidate resource in the SW is reserved. According to some embodiments of the present application, the type of the SL transmission may be identified by the UE according to the SCI detected in the sensing window announcing a reservation of the candidate resource.

Specifically, the UE may detect an SCI in the sensing window and decode the SCI. The SCI may indicate resource(s) reserved for an SL transmission, which may include an entirety of a slot level candidate resource in the SW or a part of the slot level candidate resource.

In some embodiments of the present application, the SCI may include a field of transmission type indicating whether the SL transmission is a slot-level transmission or sub-slot level transmission, such that the UE may determine whether the SL transmission is a slot level transmission or a sub-slot level transmission based on the field of transmission type in the SCI.

In some other embodiments of the present application, the UE may determine the type of the SL transmission according to a unit of the reserved resource(s) in the time domain indicated by the SCI. For example, in the case that the reserved resource(s) indicated by the SCI is represented in unit of slot, the UE may determine that the SL transmission is a slot level transmission. In the case that the reserved resource(s) indicated by the SCI is represented in unit of sub-slot, the UE may determine that the SL transmission is a sub-slot level transmission.

Consequently, based on the SCIs detected in the sensing window, the UE can identify Type 2.1, Type 2.2 and Type 2.3 slot level candidate resources in the set “S” and perform resource selection based on principle 1.

One motivation for principle 2 is that the initial transmission is more important for a successful transmission of a TB compared to retransmission of the same TB.

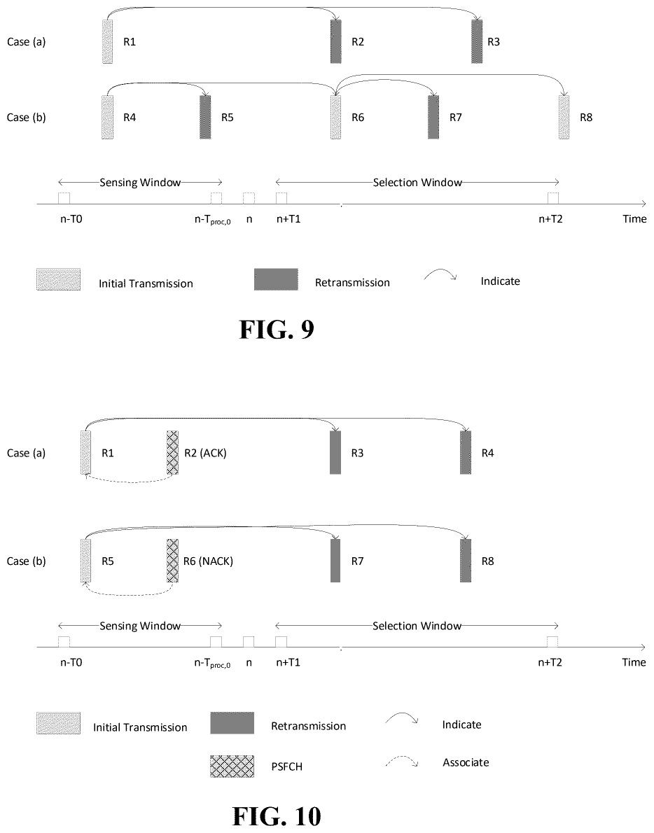

FIG. 9 illustrates an example of principle 2 of resource selection according to some embodiments of the present application. The UE may check SCI in the sensing window to determine whether the resource(s) indicated by the SCI is (are) reserved for an initial transmission or retransmission of a TB. FIG. 9 illustrates two cases for resource reservation.

In case (a), an initial transmission (e.g., R1) of a TB in the sensing window may include SCI which indicates two resources (e.g., R2 and R3) in the SW reserved for two retransmissions of the TB.

In case (b), an initial transmission (e.g., R4) of a TB in the sensing window may include SCI which indicates a resource (e.g., R5) reserved for a retransmission of the TB and a resource (e.g., R6) in the SW reserved for an initial transmission of a next TB. The initial transmission (e.g., R6) of the next TB may also include SCI which indicates a resource (e.g., R7) reserved for a retransmission of the next TB and a resource reserved for an initial transmission (e.g., R8) of a next next TB. The case (b) may represent a semi-persistent resource reservation.

The UE may identify R2, R3, and R6 based on SCIs detected in the sensing window. According to principle 2, R2 and R3 are prioritized over R6 to be selected by the UE to be included in the set “S1.” In some embodiments of the present application, principle 2 can be enhanced from the following aspects.

In one aspect, if HARQ feedback is enabled for a TB transmitted by another UE, the HARQ feedback information associated with the TB can help the UE to identify if a resource reserved for retransmission of the TB is to be used by the another UE. For example, when an acknowledgement (ACK) indicates the reception of the TB was successful, the succeeding retransmission(s) is (are) not needed, which means that the another UE will not use the resource(s) reserved for the succeeding retransmission(s) of the TB and thus such resource(s) can be prioritized when the UE selects the set “S1.”

In another aspect, if HARQ feedback is disabled for a TB, it implies that the PSSCH carrying the TB has a low priority. Then, it is feasible to prioritize the resource reserved for retransmission of the TB when the UE selects the set “S1.”

In some embodiments of the present application, whether HARQ feedback is enabled or disabled for a TB may be indicated by a one-bit HARQ-ACK enabling/disabling indicator in the SCI (e.g., 2^{nd}-stage SCI) associated with the TB. Then, after detecting the SCI associated with the TB in the sensing window, the UE may determine whether HARQ feedback is enabled or disabled for the TB based on the one-bit HARQ-ACK enabling/disabling indicator in the SCI.

Given the above, principle 2 may further include principle 2.1, i.e., prioritizing a slot level candidate resource reserved for retransmission of a TB when HARQ feedback associated with a preceding transmission of the TB (e.g., an initial transmission of the TB or a retransmission of the TB) is ACK or HARQ feedback for the TB is disabled.

FIG. 10 illustrates an example of principle 2.1 of resource selection according to some embodiments of the present application. Two cases for resource reservation are illustrated in FIG. 10.

In case (a), an initial transmission (e.g., R1) of a TB in the sensing window may include SCI (e.g., including 1^{st}-stage SCI and 2^{nd}-stage SCI) associated with the TB. The 1^{st}-stage SCI may indicate two resources (e.g., R3 and R4) in the SW reserved for two retransmissions of the TB. The 2^{nd}-stage SCI may indicate that HARQ feedback is enabled for the TB, and a PSFCH (e.g., R2) carrying ACK associated with the initial transmission (e.g., R1) of the TB is detected in the sensing window.

In case (b), an initial transmission (e.g., R5) of a TB in the sensing window may include SCI (e.g., including 1^{st}-stage SCI and 2^{nd}-stage SCI) associated with the TB. The 1^{st}-stage SCI may indicate two resources (e.g., R7 and R8) in the SW reserved for two retransmissions of the TB. The 2^{nd}-stage SCI may indicate that HARQ feedback is enabled for the TB, and a PSFCH (e.g., R6) carrying NACK associated with the initial transmission (e.g., R5) of the TB is detected in the sensing window.

Therefore, according to principle 2.1, R3 is prioritized over R7 to be selected by the UE to be included in the set “S1.”

In some embodiments of the present application, principle 2 can be enhanced from the following aspect.

Specifically, a NACK may indicate an unsuccessful reception of a TB and thus a succeeding retransmission of the TB is needed. However, if the remaining resources reserved for retransmission of the TB are sufficient, partial resources can still be occupied by the UE performing resource selection.

Given the above, principle 2 may further include principle 2.2, i.e., prioritizing a slot level candidate resource reserved for retransmission of a TB over that reserved for retransmission of another TB when HARQ feedbacks associated with a preceding transmission of the TB (e.g., an initial transmission of the TB or a retransmission of the TB) and that of the another TB are NACK and a number of remaining resources for retransmission of the TB is larger than that for retransmission of the another TB.

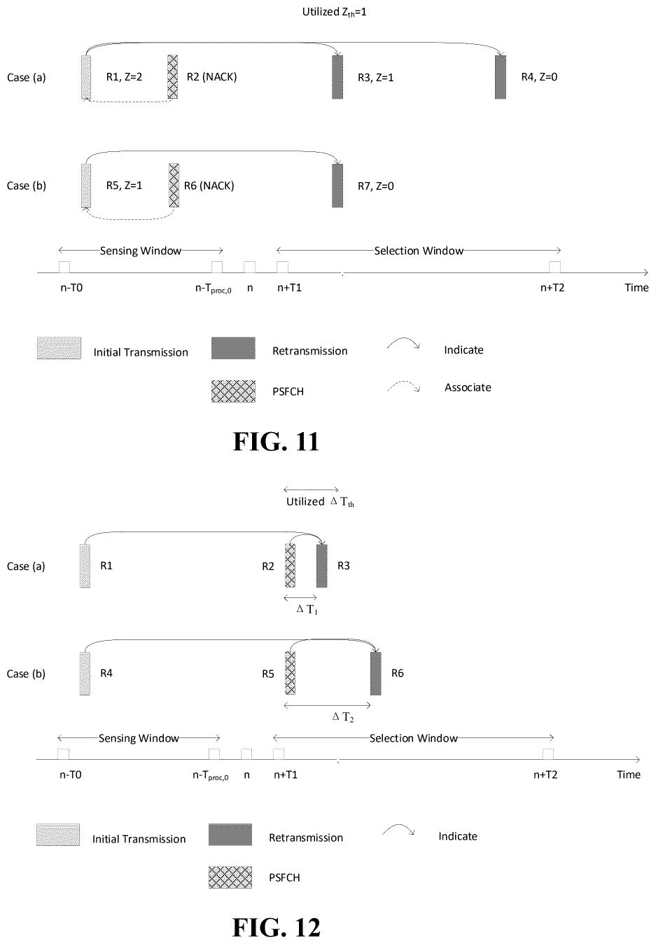

FIG. 11 illustrates an example of principle 2.2 of resource selection according to some embodiments of the present application. Two cases for resource reservation are illustrated in FIG. 11.

In case (a), an initial transmission of a TB on a resource (e.g., R1) in the sensing window may include SCI (e.g., including 1^{st}-stage SCI and 2^{nd}-stage SCI) associated with the TB. The 1^{st}-stage SCI may indicate two resources (e.g., R3 and R4) in the SW reserved for two retransmissions of the TB. That is, for the initial transmission (e.g., R1) of the TB, the number of remaining resources for retransmission of the TB is Z=2; for the first retransmission (e.g., R3) of the TB, the number of remaining resources for retransmission of the TB is Z=1; for the second retransmission (e.g., R4) of the TB, the number of remaining resources for retransmission of the TB is Z=0. The 2^{nd}-stage SCI may indicate that HARQ feedback is enabled for the TB, and a PSFCH (e.g., R2) carrying NACK associated with the initial transmission (e.g., R1) of the TB is detected in the sensing window.

In case (b), an initial transmission of a TB on a resource (e.g., R5) in the sensing window may include SCI (e.g., including 1^{st}-stage SCI and 2^{nd}-stage SCI) associated with the TB. The 1^{st}-stage SCI may indicate one resource (e.g., R7) in the SW reserved for one retransmission of the TB. That is, for the initial transmission (e.g., R5) of the TB, the number of remaining resources for retransmission of the TB is Z=1; for the retransmission (e.g., R7) of the TB, the number of remaining resources for retransmission of the TB is Z=0. The 2^{nd}-stage SCI may indicate that HARQ feedback is enabled for the TB, and a PSFCH (e.g., R6) carrying NACK associated with the initial transmission (e.g., R5) of the TB is detected in the sensing window.

Therefore, according to principle 2.2, R3 (with Z=1) is prioritized over R7 (with Z=0) to be selected by the UE to be included in the set “S1.”

In the case that the configuration information obtained in step 701 includes number threshold(s) of remaining resources for retransmission of a TB, principle 2 may further include principle 2.3, i.e., prioritizing a slot level candidate resource reserved for retransmission of a TB when HARQ feedback associated with a preceding transmission of the TB is NACK and a number of remaining resources for retransmission of the TB is larger than or equal to a number threshold indicated by the configuration information. In such embodiments, the number threshold utilized by the UE aims at guaranteeing sufficient retransmission resources for the impacted TB from another UE. For example, the number threshold(s) of remaining resources for retransmission of a TB in the configuration information may include a set of number thresholds, wherein each number threshold is associated with at least one of a priority of a TB for which the UE performs resource selection or a priority of a TB for which resource(s) in the SW of the UE is reserved. The utilized number threshold may be determined by a priority of the TB to be transmitted by the UE and/or a priority of a TB for which the slot level candidate resource is reserved.

Still referring to FIG. 11, assuming that the utilized number threshold (Zₜₕ) is set to 1, then according to principle 2.3, R3 (with Z=Zₜₕ) is prioritized over R7 (with Z<Zₜₕ) to be selected by the UE to be included in the set “S1.”

In some embodiments of the present application, when the UE is to transmit a sub-slot level transmission on a resource reserved by another UE, the UE may transmit a resource collision indicator to the another UE to indicate a resource collision on the resource. In an embodiment of the present application, the resource collision indicator may be transmitted on a PSFCH symbol which fulfills the following two conditions: (1) the resource within the PSFCH symbol is configured or pre-configured (e.g., per resource pool) for transmitting the resource collision indicator; and (2) the resource is the first one that the UE can use for transmitting the resource collision indicator after a resource for transmitting the sub-slot level transmission is determined.

In the case that the configuration information obtained in step 701 includes time offset threshold(s) for processing resource collision, principle 2 may further include principle 2.4, i.e., prioritizing a slot level candidate resource reserved for retransmission of a TB when a time offset from a PSFCH transmitting a resource collision indicator to the slot level candidate resource is larger than or equal to a time offset threshold indicated by the configuration information. In such embodiments, the time offset threshold utilized by the UE aims at guaranteeing sufficient processing time for the impacted TB from another UE. For example, the time offset threshold(s) for processing resource collision in the configuration information may include a set of time offset thresholds, wherein each time offset threshold is associated with at least one of a priority of a TB for which the UE performs resource selection or a priority of a TB for which resource(s) in the SW of the UE is reserved. The utilized time offset threshold may be determined by a priority of the TB to be transmitted by the UE and/or a priority of a TB for which the slot level candidate resource is reserved.

FIG. 12 illustrates an example of principle 2.4 of resource selection according to some embodiments of the present application. Two cases for resource reservation are illustrated in FIG. 12.

In case (a), an initial transmission of a TB on a resource (e.g., R1) in the sensing window may include SCI associated with the TB. The SCI may indicate one resource (e.g., R3) in the SW reserved for one retransmission of the TB. If the UE determines to transmit the sub-slot level transmission on R3, it will transmit a resource collision indicator in PSFCH on R2 to indicate a resource collision on R3. The UE can determine that the time offset from R2 to R3 is ΔT₁.

In case (b), an initial transmission of a TB on a resource (e.g., R4) in the sensing window may include SCI associated with the TB. The SCI may indicate one resource (e.g., R6) in the SW reserved for one retransmission of the TB. If the UE determines to transmit the sub-slot level transmission on R6, it will transmit a resource collision indicator in PSFCH on R5 to indicate a resource collision on R6. The UE can determine that the time offset from R5 to R6 is ΔT₂.

Given the utilized time offset threshold (ΔTₜₕ), according to principle 2.4, R6 (with ΔT₂<ΔTₜₕ) is prioritized over R3 (with ΔT₁<ΔTₜₕ) to be selected by the UE to be included in the set “S1.”

In the case that the configuration information obtained in step 701 includes ratio threshold(s) of unreserved resources, the UE may select the set “S1” based on principle 3, i.e., prioritizing slot level candidate resource(s) in which ratio(s) of unreserved resources is larger than or equal to a ratio threshold indicated by the configuration information. The ratio threshold utilized by the UE aims at decreasing the number of impacted TB from other UE(s). For example, the ratio threshold(s) of unreserved resources in the configuration information may include a set of ratio thresholds, wherein each ratio threshold is associated with at least one of a priority of a TB for which the UE performs resource selection or a priority of a TB for which resource(s) in the SW of the UE is reserved. The utilized ratio threshold may be determined by a priority of the TB to be transmitted by the UE and/or a priority of a TB for which the slot level candidate resource is reserved.

In order to calculate a ratio of unreserved resources in a slot level candidate resource, the slot level candidate resource may be organized into pattern blocks (PBs), each PB may occupy one sub-slot in the time domain and one sub-channel in the frequency domain, and thus each PB may be labeled by an index of sub-slot (Iss) and an index of sub-channel (I_{SCh}). In some other embodiments of the present application, the pattern block may also be referred to as pattern unit (PU), block, or unit.

Based on sensing results in the sensing window, the UE may determine a reservation status (RS) for each PB in a slot level candidate resource. Then, a ratio of unreserved resources in the slot level candidate resource may be determined by N1/N2, where N1 represents the number of PBs with an RS of “unreserved” and N2 represents the total number of PBs within the slot-level candidate resource.

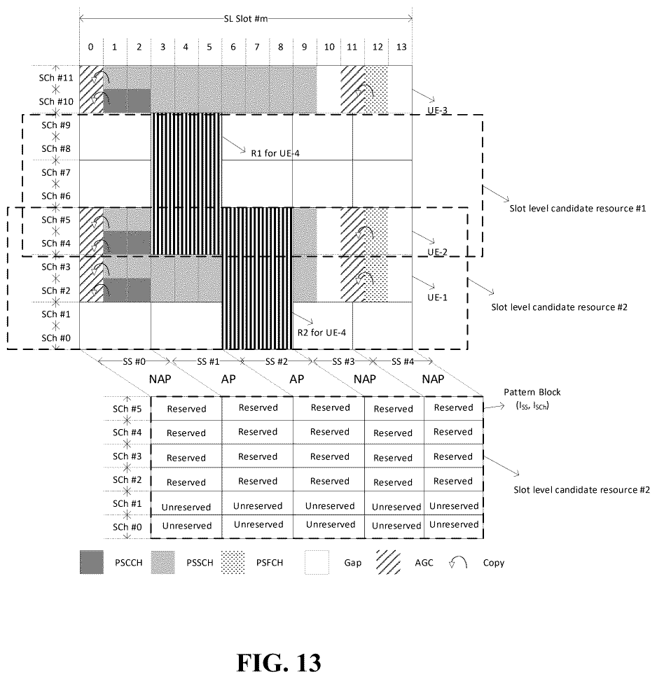

FIG. 13 illustrates an example of principle 3 of resource selection according to some embodiments of the present application. In the embodiments of FIG. 13, one slot (e.g., SL slot #m) may include 14 OFDM symbols in total, e.g., OFDM symbol #0 to OFDM symbol #13. Although a specific number of OFDM symbols in one sidelink slot are depicted in FIG. 13, it is contemplated that any number of OFDM symbols as specified in 3GPP standards may be included in one sidelink slot.

In the embodiments of FIGS. 13, 12 sub-channels (e.g., SCh #0 to SCh #11) are shown, and the slot includes five sub-slots (e.g., SS #0 to SS #4). UE-4 may be a sub-slot UE which needs to select a sub-slot level resource for its sub-slot level SL transmission. In the example shown in FIG. 13, the sub-slot level SL transmission may require one sub-slot in the time domain and six sub-channels in the frequency domain. R1 and R2 are two exemplary sub-slot level candidate resources that may be considered by the UE-4. R1 is within slot level candidate resource #1 which spans slot #m in the time domain and SCh #4 to SCh #9 in the frequency domain. R2 is within slot level candidate resource #2 which spans slot #m in the time domain and SCh #0 to SCh #5 in the frequency domain. Slot level candidate resource #1 and slot level candidate resource #2 are slot level candidate resources in the set “S” of the UE-4. Each of the slot level candidate resource includes 30 PBs in total.

Based on sensing results in a sensing window, the UE-4 may determine that: slot #m in the time domain and two consecutive sub-channels from SCh #2 to SCh #3 in the frequency domain are reserved by a slot level transmission from UE-1; slot #m in the time domain and two consecutive sub-channels from SCh #4 to SCh #5 in the frequency domain are reserved by a slot level transmission from UE-2; slot #m in the time domain and two consecutive sub-channels from SCh #10 to SCh #11 in the frequency domain are reserved by a slot level transmission from UE-3.

Then, for slot level candidate resource #1, the UE-4 may determine that the number of PBs with an RS of “unreserved” (i.e., the PBs in SCh #6 to SCh #9) is 20, and thus the radio of unreserved resources is 20/30=66.7%.

Then, for slot level candidate resource #2, the UE-4 may determine that the number of PBs with an RS of “unreserved” (i.e., the PBs in SCh #0 to SCh #1) is 10, and thus the radio of unreserved resources is 10/30=33.3%.

When the utilized ratio threshold is set to 50%, according to principle 3, slot level candidate resource #1 is prioritized over slot level candidate resource #2 to be selected by the UE-4 to be included in the set “S1.”

According to some embodiments of the present application, after selecting the set “S1” (e.g., based on at least one of the principles described above) in step 705, the UE may select a set of sub-slot level candidate resources (referred to as set “S2”) from the set “S1” based on principle 4, i.e., prioritizing sub-slot level candidate resource(s) on AP(s) over that on NAP(s) in a slot level candidate resource.

Whether a position (e.g., a symbol or a sub-slot) in a slot level candidate resource is an AP or an NAP may be determined based on the set of position characteristics indicated by the configuration information obtained in step 701.

Specifically, an AP may refer to a position available for sub-slot level transmission without affecting a slot level transmission in the same SL slot; and a NAP may refer to a position not available for sub-slot level transmission without affecting a slot level transmission in the same SL slot.

Here, “a position available for sub-slot level transmission without affecting a slot level transmission in the same SL slot” means that resource collision between the sub-slot level transmission and the slot level transmission in the same SL slot can be avoided or reduced by some means when the position is reserved for the sub-slot level transmission.

In some embodiments, different symbols or sub-slots within an SL slot may have different impacts on a successful transmission and/or reception of a slot level SL transmission on the corresponding symbols or sub-slots due to their variety of functions in the slot level SL transmission.

For example, referring to FIG. 13, the first several symbol(s) (e.g., symbols #0 to #2 as shown in FIG. 13) or sub-slot(s) (e.g., SS #0 as shown in FIG. 13) in an SL slot may be used to carry both 1^{st} stage SCI and 2^{nd} stage SCI which dominate the successful transmission and/or reception of a slot level SL transmission. Thus, the first several symbol(s) or sub-slot(s) may be indicated as NAP(s) by the corresponding position characteristic(s).

The last several symbol(s) (e.g., symbols #11 and #12 as shown in FIG. 13) or sub-slot(s) (e.g., SS #3 and SS #4 as shown in FIG. 13) in an SL slot may be used to carry PSFCH transmission if PSFCH is configured. The PSFCH transmission may be used to transmit feedback information which may affect retransmission of slot level transmission(s). Thus, the last several symbol(s) or sub-slot(s) may be indicated as NAP(s) by the corresponding position characteristic(s).

The remaining symbol(s) (e.g., symbols #3 to #9 as shown in FIG. 13) or sub-slot(s) (e.g., SS #1 and SS #2 as shown in FIG. 13) may be used to carry PSSCH transmission of a slot level SL transmission, and the impact on the slot level SL transmission caused by sub-slot level SL transmission(s) on such symbol(s) or sub-slot(s) can be reduced by some means such as at least one of the flowing technologies:
(1) puncturing slot level SL transmission on the symbol(s) or sub-slot(s) for the sub-slot level SL transmission(s) and/or applying codebook group (CBG) based transmission for the slot level SL transmission; or (2) performing rate-matching on the symbols or sub-slots for the slot level SL transmission other than the symbols or sub-slots reserved for the sub-slot level SL transmission. Consequently, such symbol(s) or sub-slot(s) may be indicated as AP(s) by the corresponding position characteristic(s).

Principle 4 is set aiming at decreasing the number of impacted slot level UEs reserving resources in slot level candidate resource(s). According to principle 4, in the example of FIG. 13, when the UE-4 selects the set “S2” from the set “S1,” sub-slot level candidate resources in SS #1 and SS #2 are prioritized over sub-slot level candidate resources in SS #0, SS #3, and SS #4.

Principle 4 may be further enhanced to leave sufficient resources for the impacted slot level transmission since PSSCH of the impacted slot level transmission is transmitted in consecutive symbols of a slot as specified in 3GPP standard documents. For example, principle 4 may further include principle 4.1, i.e., prioritizing a sub-slot level candidate resource on an AP over that on another AP being located prior to the AP in a same slot. According to principle 4.1, in the example of FIG. 13, when the UE-4 selects the set “S2” from the set “S1,” sub-slot level candidate resources in SS #2 is prioritized over sub-slot level candidate resources in SS #1.

The above embodiments describe various principles for resource selection separately. However, when performing resource selection, a sub-slot UE may apply these principles in different combinations and/or orders according to different performance targets. The following two cases (Case 1 and Case 2) provide two different examples for applying these principles.

Case 1 may include the following steps.

1) Step 0: the UE may determine Type 1 slot level candidate resources, Type 2 slot level candidate resources, and Type 3 slot level candidate resources in the set “S” determined in step 703. For example, Type 1, Type 2, and Type 3 slot level candidate resources may be determined based on the methods described with respect to FIG. 8. That is, Type 2 and Type 3 slot level candidate resources may be determined based on the sensing results (e.g., the decoded st-stage SCIs and the measured RSRPs) in the sensing window.
2) Step 1: the UE may select the set “S1” from the set “S” and further select the set “S2” from the set “S1.” Step 1 may include the following steps:
   Step 1.1: the UE may apply principle 0 to select one or more slot level candidate resources from the set “S” as a first part of the set “S1.”
      Specifically, applying principle 0 may include selecting Type 3 slot level candidate resources and selecting a part of Type 2 slot level candidate resources each of which is associated with a measured RSRP (e.g., an RSRP of an SL transmission associated with the SCI detected in the sensing window indicating that the slot level candidate resource is reserved for an SL transmission of another UE) lower than or equal to an RSRP threshold, wherein the RSRP threshold utilized by the UE may depend on at least one of (1) the priority of the TB for which the UE selects the candidate resources (also the priority of the SL transmission to be performed by the UE) or (2) the priority of a TB for which the another UE reserves the resource (also the priority of the SL transmission of the another UE).
      In some embodiments, selecting Type 3 slot level candidate resources may be implemented by one of the following means:
      directly selecting the Type 3 slot level candidate resources; or
      excluding all Type 1 and Type 2 slot level candidate resources in the set “S.”
      In some embodiments, selecting the part of Type 2 slot level candidate resources each of which is associated with a measured RSRP lower than or equal to the RSRP threshold may be implemented by one of the following means:
      directly selecting slot level candidate resource(s) each associated with a measured RSRP lower than or equal to the RSRP threshold from all the Type 2 slot level candidate resources; or
      excluding slot level candidate resource(s) each associated with a measured RSRP higher than the RSRP threshold from all the Type 2 slot level candidate resources.
   Step 1.2: the UE may apply principles 1, 2, 3, and 2.1-2.4 in a certain combination and order to select at least one Type 2 slot level candidate resource from the remaining part of Type 2 slot level candidate resources (e.g., slot level candidate resources each associated with a measured RSRP higher than the RSRP threshold) as a second part of the set “S1.”
   Step 1.3: the UE may apply at least one of principle 4 or principle 4.1 to select the set “S2” from the first part and the second part of the set “S1.”
3) Step 2: the UE may determine whether a ratio of a number of sub-slot level candidate resources included in the set “S2” to a total number of sub-slot level candidate resources included in the set “S” is larger than or equal to a threshold (e.g., X1%). In some embodiments, X1 may be determined by the UE based on a priority of the sub-slot level transmission for which the UE performs resource selection.
4) Step 3: in the case that the ratio is less than the threshold, the UE may increase the RSRP threshold by a pre-defined step (e.g., 3 dB) and repeat the step 1 until the ratio is larger than or equal to the threshold.
In the case that the ratio is larger than or equal to the threshold, the UE (e.g., the physical layer of the UE) may indicate the set “S2” to a higher layer (e.g., a MAC layer) of the UE.

Case 2 may include the following steps.
1) Step 0: the UE may determine Type 1 slot level candidate resources, Type 2 slot level candidate resources, and Type 3 slot level candidate resources in the set “S” determined in step 703. For example, Type 1, Type 2, and Type 3 slot level candidate resources may be determined based on the methods described with respect to FIG. 8. That is, Type 2 and Type 3 slot level candidate resources may be determined based on the sensing results (e.g., the decoded 1^{st}-stage SCIs and the measured RSRPs) in the sensing window.
2) Step 1: the UE may apply principle 0 to select one or more slot level candidate resources from the set “S” as a first part of the set “S1.” Specifically, applying principle 0 may include selecting Type 3 slot level candidate resources and selecting a part of Type 2 slot level candidate resources each of which is associated with a measured RSRP (e.g., an RSRP of an SL transmission associated with the SCI detected in the sensing window indicating that the slot level candidate resource is reserved for an SL transmission of another UE) lower than or equal to an RSRP threshold, wherein the RSRP threshold utilized by the UE may depend on at least one of (1) the priority of the TB for which the UE selects the candidate resources (also the priority of the SL transmission to be performed by the UE) or (2) the priority of a TB for which the another UE reserves the resource (also the priority of the SL transmission of the another UE).
   In some embodiments, selecting Type 3 slot level candidate resources may be implemented by one of the following means:
   directly selecting the Type 3 slot level candidate resources; or
   excluding all Type 1 and Type 2 slot level candidate resources in the set “S.”
   In some embodiments, selecting the part of Type 2 slot level candidate resources each of which is associated with a measured RSRP lower than or equal to the RSRP threshold may be implemented by one of the following means:
   directly selecting slot level candidate resource(s) each associated with a measured RSRP lower than or equal to the RSRP threshold from all the Type 2 slot level candidate resources; or
   excluding slot level candidate resource(s) each associated with a measured RSRP higher than the RSRP threshold from all the Type 2 slot level candidate resources.
3) Step 2: the UE may determine whether a first ratio of a number of slot level candidate resources included in the first part of the set “S1” to a total number of slot level candidate resources included in the set “S” is larger than or equal to a first threshold (e.g., X2%). In some embodiments, X2 may be determined by the UE based on a priority of the sub-slot level transmission for which the UE performs resource selection.
4) Step 3: in the case that the first ratio is less than the first threshold, the UE may increase the RSRP threshold by a pre-defined step (e.g., 3 dB) and repeat the step 1 until at least one of the following conditions is reached: (1) the first ratio is larger than or equal to the first threshold; (2) the RSRP threshold reaches a first pre-defined value (e.g., configured or pre-configured per resource pool); or (3) a number of times the RSRP threshold is increased reaches a second pre-defined value (e.g., configured or pre-configured per resource pool).
   In the case that the first ratio is larger than or equal to the first threshold, the UE may apply at least one of principle 4 or principle 4.1 to select the set “S2” from the first part of the set “S1” and indicate the set “S2” to a higher layer(e.g., a MAC layer) of the UE.
   However, in the case that the above repeating of the step 1 is stopped while the first ratio is less than the first threshold, the UE may further perform the following steps:
5) Step 4: the UE may apply principles 1, 2, 3, and 2.1-2.4 in a certain combination and order to select the remaining part of Type 2 slot level candidate resources (e.g., slot level candidate resources each associated with a measured RSRP higher than the RSRP threshold) as a second part of the set “S1.”
6) Step 5: the UE may apply at least one of principle 4 or principle 4.1 to select the set “S2” from the first part and the second part of the set “S1.”
7) Step 6: the UE may determine whether a second ratio of a number of sub-slot level candidate resources included in the set “S2” (including the first part and the second part) to the total number of sub-slot level candidate resources included in the set “S” is larger than or equal to a second threshold (e.g., X3%). In some embodiments, X3 may be determined by the UE based on a priority of the sub-slot level transmission for which the UE performs resource selection.
8) Step 7: in the case that the second ratio is less than the second threshold, the UE may increase the RSRP threshold by a pre-defined step (e.g., 3 dB) and repeat the steps 1, 4, and 5 until the second ratio is larger than or equal to the second threshold.

In the case that the second ratio is larger than or equal to the second threshold, the UE (e.g., the physical layer) may indicate the set “S2” to the higher layer of the UE.

In some embodiments of the present application, the procedures of determining the set “S,” selecting the set “S1,” and selecting the set “S2” may occur at a physical layer of the UE.

According to some embodiments of the present application, after determining the set “S2,” the physical layer of the UE may indicate the set “S2” to a higher layer of the UE. The higher layer may be a layer higher than the physical layer, e.g., a MAC layer. Then, after receiving the set “S2,” the higher layer of the UE may select a sub-slot level candidate resource from the set “S2” via a random procedure based on a unified probability for each sub-slot level candidate resource within the set “S2.”

According to some other embodiments of the present application, after determining the set “S2,” the physical layer of the UE may indicate (1) the set “S2” and (2) a type associated with each sub-slot level candidate resource in the set “S2” to the higher layer of the UE. The type associated with a respective sub-slot level candidate resource may indicate whether the respective sub-slot level candidate resource is reserved for SL transmission or not. For example, the type associated with a respective sub-slot level candidate resource may indicate that the respective sub-slot level candidate resource is a Type 3 sub-slot level candidate resource, which means that the sub-slot level candidate resource is not reserved for SL transmission, or indicate that the respective sub-slot level candidate resource is a Type 2 sub-slot level candidate resource, which means that the sub-slot level candidate resource is reserved for SL transmission. The Type 3 sub-slot level candidate resource may be a sub-slot level candidate resource selected from a Type 3 slot level candidate resource and the Type 2 sub-slot level candidate resource may be a sub-slot level candidate resource selected from a Type 2 slot level candidate resource.

In such embodiments, the UE may set different probabilities of selection to Type 3 sub-slot level candidate resource and Type 2 sub-slot level candidate resource. For example, a Type 3 sub-slot level candidate resource may have a higher probability than a Type 2 sub-slot level candidate resource when being selected. The motivation for setting different probabilities is to decrease the number of impacted UEs while obtaining random selection to avoid resource collision when selecting resource among multiple UEs.

Then, after receiving the set “S2” and associated types, the higher layer of the UE may select a sub-slot level candidate resource from the set “S2” via a random procedure based on a type associated with the sub-slot level candidate resource and different probabilities for different types.

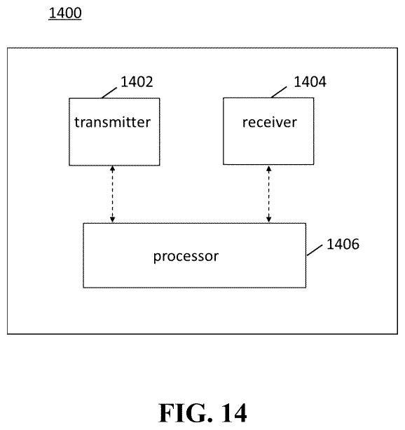

FIG. 14 illustrates a simplified block diagram of an exemplary apparatus 1400 for resource selection according to some embodiments of the present application. In some embodiments, the apparatus 1400 may be or include at least part of a UE (e.g., UE 101a or UE 101b in FIG. 1). In some other embodiments, the apparatus 1400 may be or include at least part of a BS (e.g., BS 102 in FIG. 1).

Referring to FIG. 14, the apparatus 1400 may include at least one transmitter 1402, at least one receiver 1404, and at least one processor 1406. The at least one transmitter 1402 is coupled to the at least one processor 1406, and the at least one receiver 1404 is coupled to the at least one processor 1406.

Although in this figure, elements such as the transmitter 1402, the receiver 1404, and the processor 1406 are illustrated in the singular, the plural is contemplated unless a limitation to the singular is explicitly stated. In some embodiments of the present application, the transmitter 1402 and the receiver 1404 may be combined to one device, such as a transceiver. In some embodiments of the present application, the apparatus 1400 may further include an input device, a memory, and/or other components. The transmitter 1402, the receiver 1404, and the processor 1406 may be configured to perform any of the methods described herein (e.g., the method described with respect to FIGS. 7-13).

According to some embodiments of the present application, the apparatus 1400 may be a UE, and the transmitter 1402, the receiver 1404, and the processor 1406 may be configured to perform operations of the method as described with respect to any of FIGS. 7-13. For example, the processor 1406 may be configured to: obtain configuration information indicating at least one of: time offset threshold(s) for processing resource collision; number threshold(s) of remaining resources for retransmission of a TB; ratio threshold(s) of unreserved resources; or a set of position characteristics, wherein each position characteristic indicates whether a position in an SL slot is an AP or a NAP for simultaneous sub-slot level transmission and slot level transmission. In some embodiments, the processor 1406 is further configured to determine a first set of slot level candidate resources in an SW. In some embodiments, the processor 1406 is further configured to: select a second set of slot level candidate resources from the first set of slot level candidate resources based on a sensing result in a sensing window and at least one of the following principles: principle 0: prioritizing slot level candidate resource(s) not reserved for SL transmission; principle 1 : prioritizing slot level candidate resource(s) reserved only for slot level transmission over that reserved only for sub-slot level transmission or reserved for both slot level transmission and sub-slot level transmission; principle 2 : prioritizing slot level candidate resource(s) reserved for retransmission of a TB over that reserved for initial transmission of a TB; or principle 3 : prioritizing slot level candidate resource(s) in which ratio(s) of unreserved resources is larger than or equal to a ratio threshold indicated by the configuration information.

According to some embodiments of the present application, the apparatus 1400 may be a BS. The transmitter 1402 may be configured to transmit configuration information associated with resource selection, wherein the configuration information indicates at least one of: time offset threshold(s) for processing resource collision; number threshold(s) of remaining resources for retransmission of a TB; ratio threshold(s) of unreserved resources; or a set of position characteristics, wherein each position characteristic indicates whether a position in an SL slot is an AP or a NAP for simultaneous sub-slot level transmission and slot level transmission.

In some embodiments of the present application, the apparatus 1400 may further include at least one non-transitory computer-readable medium. In some embodiments of the present disclosure, the non-transitory computer-readable medium may have stored thereon computer-executable instructions to cause the processor 1406 to implement any of the methods as described above. For example, the computer-executable instructions, when executed, may cause the processor 1406 to interact with the transmitter 1402 and/or the receiver 1404, so as to perform operations of the methods, e.g., as described with respect to FIGS. 7-13.

The method according to embodiments of the present application can also be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this application. For example, an embodiment of the present application provides an apparatus for resource selection for SL communication, including a processor and a memory. Computer programmable instructions for implementing a method for resource selection for SL communication are stored in the memory, and the processor is configured to perform the computer programmable instructions to implement the method for resource selection for SL communication. The method for resource selection for SL communication may be any method as described in the present application.

An alternative embodiment preferably implements the methods according to embodiments of the present application in a non-transitory, computer-readable storage medium storing computer programmable instructions. The instructions are preferably executed by computer-executable components preferably integrated with a network security system. The non-transitory, computer-readable storage medium may be stored on any suitable computer readable media such as RAMs, ROMs, flash memory, EEPROMs, optical storage devices (CD or DVD), hard drives, floppy drives, or any suitable device. The computer-executable component is preferably a processor but the instructions may alternatively or additionally be executed by any suitable dedicated hardware device. For example, an embodiment of the present application provides a non-transitory, computer-readable storage medium having computer programmable instructions stored therein. The computer programmable instructions are configured to implement a method for resource selection for SL communication according to any embodiment of the present application.

While this application has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the application by simply employing the elements of the independent claims. Accordingly, embodiments of the application as set forth herein are intended to be illustrative, not limiting. Various changes may be made without departing from the spirit and scope of the application.

1. A user equipment (UE) for wireless communication, comprising:
at least one memory; and
at least one processor coupled with the at least one memory and configured to cause the UE to:
obtain configuration information indicating at least one of:
time offset thresholds for processing resource collision;
number thresholds of remaining resources for retransmission of a transport block (TB);
ratio thresholds of unreserved resources; or a set of position characteristics, wherein each position characteristic indicates whether a position in a sidelink (SL) slot is an available position (AP) or a non-available position (NAP) for simultaneous sub-slot level transmission and slot level transmission;
determine a first set of slot level candidate resources in a selection window (SW);
and select a second set of slot level candidate resources from the first set of slot level candidate resources based on a sensing result in a sensing window and at least one of the following principles:
principle 0: prioritizing slot level candidate resource(s)resources not reserved for SL transmission and slot level candidate resource(s)resources associated with a measured reference signal receiving power (RSRP) lower than or equal to an RSRP threshold;
principle 1 : prioritizing slot level candidate resource(s)resources reserved only for slot level transmission over that reserved only for sub-slot level transmission or reserved for both slot level transmission and sub-slot level transmission;
principle 2 : prioritizing slot level candidate resource(s)resources reserved for retransmission of a TB over that reserved for initial transmission of a TB; or principle 3 : prioritizing slot level candidate resource(s)resources in which ratio(s)ratios of unreserved resources is larger than or equal to a ratio threshold indicated by the configuration information;

2. The UE of claim 1, wherein the at least one processor is further configured to cause the UE to: select a set of sub-slot level candidate resources from the second set of slot level candidate resources based on:
principle 4 : prioritizing sub-slot level candidate resource(s)resources on APs over NAP(s)NAPs in a slot level candidate resource.

3. The UE of claim 1, wherein the configuration information is configured or pre-configured per resource pool.

4. The UE of claim 1, wherein:
the time offset thresholds includes a set of time offset thresholds, wherein each time offset threshold is associated with at least one of a priority of a TB for which the UE performs the selecting or a priority of a TB for which resource(s)resources in the SW is reserved;
the number thresholds includes a set of number thresholds, wherein each number threshold is associated with at least one of a priority of a TB for which the UE performs the selecting or a priority of a TB for which resource(s)resources in the SW is reserved; or the ratio thresholds includes a set of ratio thresholds, wherein each ratio threshold is associated with at least one of a priority of a TB for which the UE performs the selecting or a priority of a TB for which resource(s) in the SW is reserved.

5. The UE of claim 1, wherein the isat least one processor is configured to cause the UE to: receive sidelink control information (SCI) in the sensing window, wherein the SCI indicates that resource(s)resources in the SW is reserved for an SL transmission; and
determine whether a type of the SL transmission is a slot level transmission or a sub-slot level transmission based on the SCI.

6. The UE of claim 5, wherein the at least one processor is configured to cause the UE to: determine the type of the SL transmission according to a field of transmission type in the SCI or a unit of reserved resource(s)resources the-a time domain indicated by the SCI.

7. The UE of claim 1, wherein the at least one processor is further configured to cause the UE to: prioritize slot level candidate resource(s)resources reserved for retransmission of a TB based on at least one of the following principles:
prioritizing a slot level candidate resource reserved for retransmission of a TB when hybrid automatic repeat request (HARQ) feedback associated with a preceding transmission of the TB is acknowledgement (ACK) or HARQ feedback for the TB is disabled;
prioritizing a slot level candidate resource reserved for retransmission of a TB over that reserved for retransmission of another TB when HARQ feedbacks associated with a preceding transmission of the TB and that of the another TB are non-acknowledgement (NACK) and a number of remaining resources for retransmission of the TB is larger than that for retransmission of the another TB;
prioritizing a slot level candidate resource reserved for retransmission of a TB when HARQ feedback associated with a preceding transmission of the TB is NACK and a number of remaining resources for retransmission of the TB is larger than or equal to a number threshold indicated by the configuration information; or prioritizing a slot level candidate resource reserved for retransmission of a TB when a time offset from a physical sidelink feedback channel (PSFCH) transmitting a resource collision indicator to the slot level candidate resource is larger than or equal to a time offset threshold indicated by the configuration information.

8. The UE of claim 2, wherein the at least one processor is further configured to cause the UE to: prioritize sub-slot level candidate resource(s)resources on APs based on:
prioritizing a sub-slot level candidate resource on an AP over that on another AP being located prior to the AP in a same slot.

9. The UE of claim 1, wherein, to select the second set of slot level candidate resources, the at least one processor is further configured to performcause the UE to:
selectingselect slot level candidate resource(s)resources from the first set of slot level candidate resources as a first part of the second set of slot level candidate resources by applying principle 0;
determiningdetermine whether a first ratio of a number of slot level candidate resources included in the first part to a number of slot level candidate resources included in the first set of slot level candidate resources is larger than or equal to a first threshold; and
thatwhen the first ratio is less than the first threshold, increase the RSRP threshold by a pre-defined step and repeat selection of the slot level candidate 1 until at least one of the following conditions is reached: (1) the first ratio is larger than or equal to the first threshold; (2) the RSRP threshold reaches a first pre-defined value; or (3) a number of times the RSRP threshold is increased reaches a second pre-defined value.

10. The UE of claim 2, wherein the at least one processor is further configured to cause the UE to: indicate the set of sub-slot level candidate resources and a type associated with each sub-slot level candidate resource in the set of sub-slot level candidate resources to a higher layer of the UE, wherein the type associated with a respective sub-slot level candidate resource indicates whether the respective sub-slot level candidate resource is reserved for SL transmission or not.

11. The UE of claim 10, wherein the at least one_processor is further configured to cause the UE to: select a sub-slot level candidate resource from the set of sub-slot level candidate resources via a random procedure based on a type associated with the sub-slot level candidate resource and different probabilities for different types.

12. A base station (BS) for wireless communication, comprising:
at least one memory; and
at least one processor coupled with the at least one memory and configured to cause the BS toa transmit configuration information associated with resource selection, wherein the configuration information indicates at least one of:
time offset thresholds for processing resource collision;
number thresholds of remaining resources for retransmission of a transport block (TB);
ratio thresholds of unreserved resources; or a set of position characteristics, wherein each position characteristic indicates whether a position in a sidelink (SL) slot is an available position (AP) or a non-available position (NAP) for simultaneous sub-slot level transmission and slot level transmission;

13. A method performed by a user equipment (UE), the method comprising:
obtaining configuration information indicating at least one of:
time offset thresholds for processing resource collision;
number thresholds of remaining resources for retransmission of a transport block (TB);
ratio thresholds of unreserved resources; or a set of position characteristics, wherein each position characteristic indicates whether a position in a sidelink (SL) slot is an available position (AP) or a non-available position (NAP) for simultaneous sub-slot level transmission and slot level transmission;
determining a first set of slot level candidate resources in a selection window (SW); and
selecting a second set of slot level candidate resources from the first set of slot level candidate resources based on a sensing result in a sensing window and at least one of the following principles:
prioritizing slot level candidate resource(s)resources not reserved for SL transmission and slot level candidate resource(s)resources associated with a measured reference signal receiving power (RSRP) lower than or equal to an RSRP threshold;
prioritizing slot level candidate resource(s)resources reserved only for slot level transmission over that reserved only for sub-slot level transmission or reserved for both slot level transmission and sub-slot level transmission;
prioritizing slot level candidate resource(s)resources reserved for retransmission of a TB over that reserved for initial transmission of a TB; or prioritizing slot level candidate resource(s)resources in which ratio(s)ratios of unreserved resources is larger than or equal to a ratio threshold indicated by the configuration information.

14. The method of claim 13, further comprising: selecting a set of sub-slot level candidate resources from the second set of slot level candidate resources based on:
principle 4 : prioritizing sub-slot level candidate resources on APs over NAPs in a slot level candidate resource.

15. The method of claim 13, further comprising:
receiving sidelink control information (SCI) in the sensing window, wherein the SCI indicates that resources in the SW is reserved for an SL transmission; and
determining whether a type of the SL transmission is a slot level transmission or a sub-slot level transmission based on the SCI.

16. A processor for wireless communication, comprising:
at least one controller coupled with the at least one memory and configured to cause the processor to:
obtain configuration information indicating at least one of:
time offset thresholds for processing resource collision;
number thresholds of remaining resources for retransmission of a transport block (TB);
ratio thresholds of unreserved resources; or a set of position characteristics, wherein each position characteristic indicates whether a position in a sidelink (SL) slot is an available position (AP) or a non-available position (NAP) for simultaneous sub-slot level transmission and slot level transmission;
determine a first set of slot level candidate resources in a selection window (SW);
and select a second set of slot level candidate resources from the first set of slot level candidate resources based on a sensing result in a sensing window and at least one of the following principles:
principle 0: prioritizing slot level candidate resources not reserved for SL transmission and slot level candidate resources associated with a measured reference signal receiving power (RSRP) lower than or equal to an RSRP threshold;
principle 1 : prioritizing slot level candidate resources reserved only for slot level transmission over that reserved only for sub-slot level transmission or reserved for both slot level transmission and sub-slot level transmission;
principle 2 : prioritizing slot level candidate resources reserved for retransmission of a TB over that reserved for initial transmission of a TB; or principle 3 : prioritizing slot level candidate resources in which ratios of unreserved resources is larger than or equal to a ratio threshold indicated by the configuration information.

17. The processor of claim 16, wherein the at least one controller is further configured to cause the processor to: select a set of sub-slot level candidate resources from the second set of slot level candidate resources based on:
principle 4 : prioritizing sub-slot level candidate resources on APs over NAPs in a slot level candidate resource.

18. The processor of claim 17, wherein the at least one controller is further configured to cause the processor to: prioritize sub-slot level candidate resources on APs based on:
prioritizing a sub-slot level candidate resource on an AP over that on another AP being located prior to the AP in a same slot.

19. The processor of claim 17, wherein the at least one controller is further configured to cause the processor to: indicate the set of sub-slot level candidate resources and a type associated with each sub-slot level candidate resource in the set of sub-slot level candidate resources to a higher layer of the UE, wherein the type associated with a respective sub-slot level candidate resource indicates whether the respective sub-slot level candidate resource is reserved for SL transmission or not.

20. The processor of claim 16, wherein the at least one controller is configured to cause the processor to: receive sidelink control information (SCI) in the sensing window, wherein the SCI indicates that resources in the SW is reserved for an SL transmission; and
determine whether a type of the SL transmission is a slot level transmission or a sub-slot level transmission based on the SCI.
